(19) United States
(12) Patent Application Publication
(10) Pub. No.: US 2017/0182886 A1
(43) Pub. Date: Jun. 29, 2017

(54) CONTROL SYSTEM FOR VEHICLE, AND CONTROL METHOD FOR VEHICLE

(71) Applicant: Toyota Jidosha Kabushiki Kaisha, Toyota-shi Aichi-ken (JP)

(72) Inventors: Ryota Horie, Nagoya-shi Aichi-ken (JP); Takahiro Yoshimura, Toyota-shi Aichi-ken (JP); Ryohei Yuasa, Okazaki-shi Aichi-ken (JP); Shunro Fukada, Toyota-shi Aichi-ken (JP)

(21) Appl. No.: 15/388,291

(22) Filed: Dec. 22, 2016

(30) Foreign Application Priority Data
Dec. 26, 2015 (JP) 2015-255520

(51) Int. Cl. B60K 17/354; F16D 48/06; F16D 23/02; B60K 17/02; F16D 27/12

(52) U.S. Cl. CPC B60K 17/354; B60K 17/02; F16D 27/12; F16D 23/02; F16D 48/064; F16D 2500/10431; F16D 2500/10456; F16D 2500/1107; F16D 2500/50638

(57) ABSTRACT

A synchromesh mechanism is activated when cancelling a disconnection state, and, when an electronic control unit determines that a rotation speed of an input shaft has been synchronized with a rotation speed of a first ring gear, a second intermeshing clutch is engaged, and then a first intermeshing clutch is engaged. For this reason, in the first intermeshing clutch, a decrease in the rotation speed of the first ring gear is suppressed as a result of engagement of the second intermeshing clutch. This suppresses out of synchronization between the rotation speed of the first ring gear and the rotation speed of the input shaft at the time when the first intermeshing clutch is engaged.

### CROSS-REFERENCE TO RELATED APPLICATIONS

This application claims priority to Japanese Patent Application No. 2015-255520 filed on Dec. 26, 2015, which is incorporated herein by reference in its entirety including the specification, drawings and abstract.

### BACKGROUND

1. Technical Field

The disclosure relates to, in a four-wheel drive vehicle including an intermeshing clutch that synchronizes the rotation speed of an input rotating member with the rotation speed of an output rotating member with the use of a synchromesh mechanism and then connects the output rotating member to the input rotating member by meshing a sleeve, spline-fitted to the input rotating member, with the output rotating member, a technique for reducing out of synchronization between the rotation speed of the input rotating member and the rotation speed of the output rotating member at the time of meshing the sleeve with the output rotating member as compared to the existing art.

2. Description of Related Art

There is known a four-wheel drive vehicle that has a disconnection function and that includes the following (a) to (h). The four-wheel drive vehicle having a disconnection function includes (a) main drive wheels and auxiliary drive wheels, (b) a first input rotating member to which part of power that is transmitted from a driving source to the main drive wheels is input, (c) a first output rotating member that is coupled to the auxiliary drive wheels via a power transmission member and that rotates around a first axis around which the first input rotating member rotates, (d) a first intermeshing clutch including a first sleeve that is spline-fitted to the first input rotating member and that moves in a direction of the first axis to selectively mesh with the first rotating member, (e) a second input rotating member that is provided in a power transmission path between the power transmission member and the auxiliary drive wheels and that is coupled to the auxiliary drive wheels, (f) a second output rotating member that is provided in the power transmission path between the power transmission member and the auxiliary drive wheels and that rotates around a second axis around which the second input rotating member rotates, (g) a second intermeshing clutch including a second sleeve that is spline-fitted to the second input rotating member and that moves in a direction of the second axis to selectively mesh with the second output rotating member, and (h) a synchromesh mechanism that is provided in the first intermeshing clutch, that is arranged in series with the first sleeve in the direction of the first axis and that synchronizes the rotation speed of the first input rotating member with the rotation speed of the first output rotating member by moving the first sleeve in the direction of the first axis. This is, for example, a four-wheel drive vehicle having a disconnection function, described in Japanese Patent Application Publication No. 2015-193368 (JP 2015-193368 A). In the four-wheel drive vehicle described in JP 2015-193368 A, the first intermeshing clutch includes the synchromesh mechanism, and the second intermeshing clutch does not include the synchromesh mechanism.

In the four-wheel drive vehicle described in JP 2015-193368 A, a disconnection state is cancelled by engaging both the first intermeshing clutch and the second intermeshing clutch. The disconnection state is a state where transmission of power from the driving source and the auxiliary drive wheels to the power transmission member is interrupted by releasing the first intermeshing clutch and the second intermeshing clutch. At the time of cancelling the disconnection state, in the first intermeshing clutch, the rotation speed of the first input rotating member is synchronized with the rotation speed of the first output rotating member by moving the first sleeve in the direction of the first axis to activate the synchromesh mechanism, and then the sleeve meshes with the first output rotating member.

### SUMMARY

Incidentally, in the thus configured four-wheel drive vehicle, when cancelling the disconnection state, if a time from when the synchromesh mechanism is activated to when the first sleeve meshes with the first output rotating member is relatively long in the first intermeshing clutch, there is an inconvenience that tooth hammer noise increases at the time when the first intermeshing clutch is engaged. For example, when the rotation speed of the first output rotating member decreases due to rotational resistance, or the like, of the power transmission member, and the like, out of synchronization between the rotation speed of the first input rotating member and the rotation speed of the first output rotating member becomes relatively large, so tooth hammer noise increases at the time when the first intermeshing clutch is engaged.

The disclosure provides a control system for a four-wheel drive vehicle, which reduces out of synchronization between the rotation speed of an output rotating member and the rotation speed of an input rotating member at the time when an intermeshing clutch is engaged as compared to the existing art.

A first aspect of the disclosure provides a control system for a vehicle. The control system includes main drive wheels, auxiliary drive wheels, a first input rotating member, a first output rotating member, a first intermeshing clutch, a second input rotating member, a second output rotating member, a second intermeshing clutch, a synchromesh mechanism and an electronic control unit. The first input rotating member configured to be input part of power that is transmitted from a driving source to the main drive wheels. The first output rotating member coupled to the auxiliary drive wheels via a power transmission member, the first output rotating member is configured to rotate around a first axis around which the first input rotating member rotates. The first intermeshing clutch includes a first sleeve, the first sleeve being spline-fitted to one of the first input rotating member and the first output rotating member, the first sleeve is configured to move in a direction of the first axis to selectively mesh with the other one of the first input rotating member and the first output rotating member. The second input rotating member provided in a power transmission path between the power transmission member and the auxiliary drive wheels, the second input rotating member is configured to be coupled to the auxiliary drive wheels. The second output rotating member provided in the power transmission path between the power transmission member and the auxiliary drive wheels, the second output rotating member is configured to rotate around a second axis around which the second input rotating member rotates. The second intermeshing clutch includes a second sleeve, the second sleeve is spline-fitted to one of the second input rotating member and the second output rotating member, the second sleeve is configured to move in a direction of the second axis to selectively mesh with the other one of the second input rotating member and the second output rotating member. The synchromesh mechanism provided in the first intermeshing clutch, the synchromesh mechanism is arranged in series with the first sleeve in the direction of the first axis, the synchromesh mechanism is configured to synchronize a rotation speed of the first input rotating member with a rotation speed of the first output rotating member by moving the first sleeve in the direction of the first axis. The electronic control unit configured to activate the synchromesh mechanism when cancelling a disconnection state where the power transmission member is disconnected from transmission of power from the driving source and the auxiliary drive wheels, and the electronic control unit bring configured to engage the second intermeshing clutch and then engage the first intermeshing clutch when the electronic control unit determines that the rotation speed of the first input rotating member has been synchronized with the rotation speed of the first output rotating member.

According to the disclosure, the electronic control unit activates the synchromesh mechanism when cancelling the disconnection state where the power transmission member is disconnected from transmission of power from the driving source and the auxiliary drive wheels. When the electronic control unit determines that the rotation speed of the first input rotating member has been synchronized with the rotation speed of the first output rotating member or determines that the rotation speed of the second input rotating member has been synchronized with the rotation speed of the second output rotating member, the electronic control unit engages one of the first intermeshing clutch and the second intermeshing clutch, not including the synchromesh mechanism. After that, the electronic control unit engages the other one of the first intermeshing clutch and the second intermeshing clutch, including the synchromesh mechanism. For this reason, the synchromesh mechanism is activated to raise the rotation speed of the output rotating member of the intermeshing clutch, not including the synchromesh mechanism, via the intermeshing clutch including the synchromesh mechanism. For this reason, the rotation speed of the output rotating member is smoothly synchronized with the rotation speed of the input rotating member at the time when the intermeshing clutch not including the synchromesh mechanism is engaged. When the intermeshing clutch not including the synchromesh mechanism is engaged, a decrease in the rotation speed of the output rotating member of the intermeshing clutch including the synchromesh mechanism is suppressed. This suppresses out of synchronization between the rotation speed of the output rotating member and the rotation speed of the input rotating member at the time when the intermeshing clutch including the synchromesh mechanism is engaged.

In the control system for a vehicle, the main drive wheels may be front wheels, and the auxiliary drive wheels may be rear wheels. The first sleeve may be spline-fitted to the first input rotating member, and the first sleeve be configured to move in the direction of the first axis to selectively mesh with the first output rotating member. The second sleeve may be spline-fitted to the second input rotating member, and the second sleeve be configured to move in the direction of the second axis to selectively mesh with the second output rotating member. The electronic control unit may be configured to activate the synchromesh mechanism when cancelling the disconnection state. Further, the electronic control unit may be configured to synchronize the rotation speed of the first input rotating member with the rotation speed of the first output rotating member and then engage the second intermeshing clutch, and be configured to engage the second intermeshing clutch and then engage the first intermeshing clutch.

According to the disclosure, when cancelling the disconnection state of the front-engine front-drive (FF)-based four-wheel drive vehicle, out of synchronization between the rotation speed of the first output rotating member and the rotation speed of the first input rotating member at the time when the first intermeshing clutch is engaged is suitably suppressed.

In the control system for a vehicle, the synchromesh mechanism may be configured to synchronize the rotation speed of the first input rotating member with the rotation speed of the first output rotating member by moving the first sleeve in the direction of the first axis and in a non-meshing direction in which the first sleeve does not mesh with the first output rotating member.

According to the disclosure, out of synchronization between the rotation speed of the first output rotating member and the rotation speed of the first input rotating member at the time when the first sleeve is moved in a meshing direction in which the first sleeve meshes with the first output rotating member is suitably suppressed.

In the control system for a vehicle, the control system may be includes a coupling. The coupling provided in a power transmission path between the power transmission member and the second output rotating member.

According to the disclosure, it is possible to carry out suitable meshing even when the second intermeshing clutch does not include the synchromesh mechanism.

In the control system for a vehicle, the electronic control unit may be configured to engage the coupling when cancelling the disconnection state.

According to the disclosure, when the synchromesh mechanism is activated, the rotation speed of the second output rotating member of the second intermeshing clutch is suitably raised to the rotation speed of the second input rotating member.

In the control system for a vehicle, the control system may be includes a first actuating mechanism. The first actuating mechanism provided in the first intermeshing clutch, and the first actuating mechanism is configured to move the first sleeve in the direction of the first axis to move the first sleeve between a first connection position and a first disconnection position. The first connection position is a position at which the first intermeshing clutch is engaged, the first disconnection position is a position at which the first intermeshing clutch is released. The first actuating mechanism includes a first latch mechanism, and the first latch mechanism includes a first piston, a second piston and a first holder. The first piston configured to reciprocate in the direction of the first axis by a predetermined stroke as a first electromagnetic coil attracts a movable piece as a result of supplying a first electromagnetic coil current from the electronic control unit to the first electromagnetic coil. The second piston configured to be moved by the first piston in the direction of the first axis against an urging force of a first spring. The first holder has latch teeth, the first holder is configured to latch the second piston, moved by the first piston, with the latch teeth. The first latch mechanism is configured such that the first sleeve is moved to the first disconnection position by the second piston as a result of reciprocating the first piston in the direction of the first axis, and the first latch mechanism is configured such that the second piston is unlatched from the latch teeth of the first holder and the first sleeve is moved to the first connection position when the first piston is reciprocated in the direction of the first axis again.

According to the disclosure, even in a state where the first electromagnetic coil current is not supplied to the first electromagnetic coil, the first sleeve is latched at the first disconnection position with the latch teeth of the first holder via the second piston, so electric power consumption in the first intermeshing clutch is suitably reduced.

In the control system for a vehicle, the control system may be includes a second actuating mechanism. The second actuating mechanism provided in the second intermeshing clutch, and the second actuating mechanism is configured to move the second sleeve in the direction of the second axis to move the second sleeve between a second connection position and a second disconnection position. The second connection position is a position at which the second intermeshing clutch is engaged, the second disconnection position is a position at which the second intermeshing clutch is released. The second actuating mechanism includes a second latch mechanism, and the second latch mechanism includes a third piston, a fourth piston and a second holder. The third piston configured to reciprocate in the direction of the second axis by a predetermined stroke as a second electromagnetic coil attracts a movable piece as a result of supplying a second electromagnetic coil current from the electronic control unit to the second electromagnetic coil. The fourth piston configured to be moved by the third piston in the direction of the second axis against an urging force of a second spring. The second holder has latch teeth, the second holder is configured to latch the fourth piston, moved by the third piston, with the latch teeth. The second latch mechanism is configured such that the second sleeve is moved to the second disconnection position by the fourth piston as a result of reciprocating the third piston in the direction of the second axis, and the second latch mechanism is configured such that the fourth piston is unlatched from the latch teeth of the second holder and the second sleeve is moved to the second connection position when the third piston is reciprocated in the direction of the second axis again.

According to the disclosure, even in a state where the second electromagnetic coil current is not supplied to the second electromagnetic coil, the second sleeve is latched at the second disconnection position with the latch teeth of the second holder via the fourth piston, so electric power consumption in the second intermeshing clutch is suitably reduced.

A second aspect of the disclosure provides a control system for a vehicle. The control system includes main drive wheels, auxiliary drive wheels, a first input rotating member, a first output rotating member, a first intermeshing clutch, a second input rotating member, a second output rotating member, a second intermeshing clutch, a synchromesh mechanism and an electronic control unit. The first input rotating member configured to be input part of power that is transmitted from a driving source to the main drive wheels. The first output rotating member coupled to the auxiliary drive wheels via a power transmission member, the first output rotating member is configured to rotate around a first axis around which the first input rotating member rotates. The first intermeshing clutch includes a first sleeve, the first sleeve is spline-fitted to one of the first input rotating member and the first output rotating member. The first sleeve is configured to move in a direction of the first axis to selectively mesh with the other one of the first input rotating member and the first output rotating member. The second input rotating member provided in a power transmission path between the power transmission member and the auxiliary drive wheels, the second input rotating member is configured to be coupled to the auxiliary drive wheels. The second output rotating member provided in the power transmission path between the power transmission member and the auxiliary drive wheels, the second output rotating member is configured to rotate around a second axis around which the second input rotating member rotates. The second intermeshing clutch includes a second sleeve, the second sleeve is spline-fitted to one of the second input rotating member and the second output rotating member. The second sleeve is configured to move in a direction of the second axis to selectively mesh with the other one of the second input rotating member and the second output rotating member. The synchromesh mechanism provided in the second intermeshing clutch, the synchromesh mechanism is arranged in series with the second sleeve in the direction of the second axis. The synchromesh mechanism is configured to synchronize a rotation speed of the second input rotating member with a rotation speed of the second output rotating member by moving the second sleeve in the direction of the second axis. The electronic control unit configured to activate the synchromesh mechanism when cancelling a disconnection state where the power transmission member is disconnected from transmission of power from the driving source and the auxiliary drive wheels, and the electronic control unit being configured to engage the first intermeshing clutch and then engage the second intermeshing clutch when the electronic control unit determines that the rotation speed of the second input rotating member has been synchronized with the rotation speed of the second output rotating member.

According to the disclosure, the electronic control unit activates the synchromesh mechanism when cancelling the disconnection state where the power transmission member is disconnected from transmission of power from the driving source and the auxiliary drive wheels. When the electronic control unit determines that the rotation speed of the first input rotating member has been synchronized with the rotation speed of the first output rotating member or determines that the rotation speed of the second input rotating member has been synchronized with the rotation speed of the second output rotating member, the electronic control unit engages one of the first intermeshing clutch and the second intermeshing clutch, not including the synchromesh mechanism. After that, the electronic control unit engages the other one of the first intermeshing clutch and the second intermeshing clutch, including the synchromesh mechanism. For this reason, the synchromesh mechanism is activated to raise the rotation speed of the output rotating member of the intermeshing clutch, not including the synchromesh mechanism, via the intermeshing clutch including the synchromesh mechanism. For this reason, the rotation speed of the output rotating member is smoothly synchronized with the rotation speed of the input rotating member at the time when the intermeshing clutch not including the synchromesh mechanism is engaged. When the intermeshing clutch not including the synchromesh mechanism is engaged, a decrease in the rotation speed of the output rotating member of the intermeshing clutch including the synchromesh mechanism is suppressed. This suppresses out of synchronization between the rotation speed of the output rotating member and the rotation speed of the input rotating member at the time when the intermeshing clutch including the synchromesh mechanism is engaged.

A thread aspect of the disclosure provides a control method for a vehicle. The vehicle includes main drive wheels, auxiliary drive wheels, a first input rotating member, a first output rotating member, a first intermeshing clutch, a second input rotating member, a second output rotating member, a synchromesh mechanism and an electronic control unit. The first input rotating member configured to be input part of power that is transmitted from a driving source to the main drive wheels. The first output rotating member coupled to the auxiliary drive wheels via a power transmission member, the first output rotating member is configured to rotate around a first axis around which the first input rotating member rotates. The first intermeshing clutch includes a first sleeve, the first sleeve being spline-fitted to one of the first input rotating member and the first output rotating member. The first sleeve is configured to move in a direction of the first axis to selectively mesh with the other one of the first input rotating member and the first output rotating member. The second input rotating member provided in a power transmission path between the power transmission member and the auxiliary drive wheels, the second input rotating member is configured to be coupled to the auxiliary drive wheels. The second output rotating member provided in the power transmission path between the power transmission member and the auxiliary drive wheels, the second output rotating member is configured to rotate around a second axis around which the second input rotating member rotates. The second intermeshing clutch includes a second sleeve, the second sleeve is spline-fitted to one of the second input rotating member and the second output rotating member. The second sleeve is configured to move in a direction of the second axis to selectively mesh with the other one of the second input rotating member and the second output rotating member. The synchromesh mechanism provided in the first intermeshing clutch, the synchromesh mechanism is arranged in series with the first sleeve in the direction of the first axis, the synchromesh mechanism is configured to synchronize a rotation speed of the first input rotating member with a rotation speed of the first output rotating member by moving the first sleeve in the direction of the first axis. The control method includes activating, the electronic control unit, the synchromesh mechanism when cancelling a disconnection state where the power transmission member is disconnected from transmission of power from the driving source and the auxiliary drive wheels, and engaging, the electronic control unit, the second intermeshing clutch and then engaging the first intermeshing clutch when the electronic control unit determines that the rotation speed of the first input rotating member has been synchronized with the rotation speed of the first output rotating member.

According to the disclosure, the electronic control unit activates the synchromesh mechanism when cancelling the disconnection state where the power transmission member is disconnected from transmission of power from the driving source and the auxiliary drive wheels. When the electronic control unit determines that the rotation speed of the first input rotating member has been synchronized with the rotation speed of the first output rotating member or determines that the rotation speed of the second input rotating member has been synchronized with the rotation speed of the second output rotating member, the electronic control unit engages one of the first intermeshing clutch and the second intermeshing clutch, not including the synchromesh mechanism. After that, the electronic control unit engages the other one of the first intermeshing clutch and the second intermeshing clutch, including the synchromesh mechanism. For this reason, the synchromesh mechanism is activated to raise the rotation speed of the output rotating member of the intermeshing clutch, not including the synchromesh mechanism, via the intermeshing clutch including the synchromesh mechanism. For this reason, the rotation speed of the output rotating member is smoothly synchronized with the rotation speed of the input rotating member at the time when the intermeshing clutch not including the synchromesh mechanism is engaged. When the intermeshing clutch not including the synchromesh mechanism is engaged, a decrease in the rotation speed of the output rotating member of the intermeshing clutch including the synchromesh mechanism is suppressed. This suppresses out of synchronization between the rotation speed of the output rotating member and the rotation speed of the input rotating member at the time when the intermeshing clutch including the synchromesh mechanism is engaged.

A forth aspect of the disclosure provides a control method for a vehicle. The vehicle includes main drive wheels, auxiliary drive wheels, a first input rotating member, a first output rotating member, a first intermeshing clutch, a second input rotating member, a second output rotating member, a synchromesh mechanism and an electronic control unit. The first input rotating member configured to be input part of power that is transmitted from a driving source to the main drive wheels. The first output rotating member coupled to the auxiliary drive wheels via a power transmission member, the first output rotating member is configured to rotate around a first axis around which the first input rotating member rotates. The first intermeshing clutch includes a first sleeve, the first sleeve being spline-fitted to one of the first input rotating member and the first output rotating member. The first sleeve is configured to move in a direction of the first axis to selectively mesh with the other one of the first input rotating member and the first output rotating member. The second input rotating member provided in a power transmission path between the power transmission member and the auxiliary drive wheels, the second input rotating member is configured to be coupled to the auxiliary drive wheels. The second output rotating member provided in the power transmission path between the power transmission member and the auxiliary drive wheels, the second output rotating member is configured to rotate around a second axis around which the second input rotating member rotates. The second intermeshing clutch includes a second sleeve, the second sleeve is spline-fitted to one of the second input rotating member and the second output rotating member. The second sleeve is configured to move in a direction of the second axis to selectively mesh with the other one of the second input rotating member and the second output rotating member. The synchromesh mechanism provided in the first intermeshing clutch, the synchromesh mechanism is arranged in series with the first sleeve in the direction of the first axis, the synchromesh mechanism is configured to synchronize a rotation speed of the first input rotating member with a rotation speed of the first output rotating member by moving the first sleeve in the direction of the first axis. The control method includes activating, the electronic control unit, the synchromesh mechanism when cancelling a disconnection state where the power transmission member is disconnected from transmission of power from the driving source and the auxiliary drive wheels, and engaging, the electronic control unit, the first intermeshing clutch and then engaging the second intermeshing clutch when the electronic control unit determines that the rotation speed of the second input rotating member has been synchronized with the rotation speed of the second output rotating member.

According to the disclosure, the electronic control unit activates the synchromesh mechanism when cancelling the disconnection state where the power transmission member is disconnected from transmission of power from the driving source and the auxiliary drive wheels. When the electronic control unit determines that the rotation speed of the first input rotating member has been synchronized with the rotation speed of the first output rotating member or determines that the rotation speed of the second input rotating member has been synchronized with the rotation speed of the second output rotating member, the electronic control unit engages one of the first intermeshing clutch and the second intermeshing clutch, not including the synchromesh mechanism. After that, the electronic control unit engages the other one of the first intermeshing clutch and the second intermeshing clutch, including the synchromesh mechanism. For this reason, the synchromesh mechanism is activated to raise the rotation speed of the output rotating member of the intermeshing clutch, not including the synchromesh mechanism, via the intermeshing clutch including the synchromesh mechanism. For this reason, the rotation speed of the output rotating member is smoothly synchronized with the rotation speed of the input rotating member at the time when the intermeshing clutch not including the synchromesh mechanism is engaged. When the intermeshing clutch not including the synchromesh mechanism is engaged, a decrease in the rotation speed of the output rotating member of the intermeshing clutch including the synchromesh mechanism is suppressed. This suppresses out of synchronization between the rotation speed of the output rotating member and the rotation speed of the input rotating member at the time when the intermeshing clutch including the synchromesh mechanism is engaged.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a skeletal view that schematically illustrates the configuration of a four-wheel drive vehicle to which the disclosure is suitably applied;

FIG. 2 is a cross-sectional view that illustrates the configuration of a transfer provided in the four-wheel drive vehicle shown in FIG. 1, and is a view that shows a state where a first movable sleeve provided in the transfer is placed at a first disconnection position;

FIG. 3 is a schematic view that illustrates the operation principle of a ratchet mechanism provided in each of the transfer shown in FIG. 2 and a rear wheel driving force distribution unit shown in FIG. 4;

FIG. 4 is a cross-sectional view that illustrates the configuration of the rear wheel driving force distribution unit provided in the four-wheel drive vehicle shown in FIG. 1, and is a view that shows a state where a second movable sleeve provided in the rear wheel driving force distribution unit is placed at a second disconnection position;

FIG. 5 is a functional block diagram that illustrates a relevant portion of control functions provided in an electronic control unit of the four-wheel drive vehicle shown in FIG. 1;

FIG. 6 is a flowchart that illustrates an example of control operations of engagement control for engaging a first intermeshing clutch and a second intermeshing clutch when cancellation of disconnection for cancelling a disconnection state in the electronic control unit shown in FIG. 1;

FIG. 7 is a timing chart in the case where the control operations shown in the flowchart of FIG. 6 are executed; and

FIG. 8 is a skeletal view that schematically illustrates the configuration of a four-wheel drive vehicle according to another embodiment.

### DETAILED DESCRIPTION OF EMBODIMENTS

Hereinafter, embodiments of the disclosure will be described in detail with reference to the accompanying drawings. In the following embodiments, the drawings are simplified or modified where appropriate, and the scale ratio, shape, and the like, of each portion are not always accurately drawn.

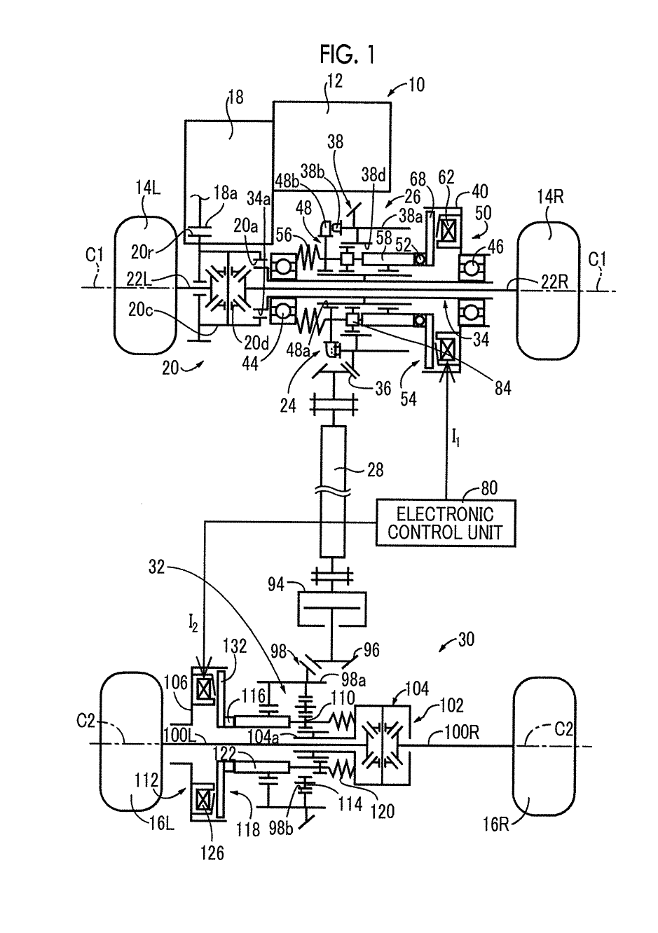

FIG. 1 is a skeletal view that schematically illustrates the configuration of a four-wheel drive vehicle 10 to which the disclosure is suitably applied. As shown in FIG. 1, the four-wheel drive vehicle 10 includes a front-engine front-drive (FF) four-wheel drive-based four-wheel drive system that uses an engine 12 as a driving source and includes a first power transmission path and a second power transmission path. The first power transmission path transmits the power of the engine 12 to right and left front wheels 14R, 14L (when not specifically distinguished from each other, referred to as front wheels 14) corresponding to the main drive wheels. The second power transmission path transmits the power of the engine 12 to right and left rear wheels 16R, 16L (when not specifically distinguished from each other, referred to as rear wheels 16) corresponding to the auxiliary drive wheels. In a two-wheel drive mode of the four-wheel drive vehicle 10, driving force transmitted from the engine 12 via an automatic transmission 18 is transmitted to the right and left front wheels 14R, 14L through a front wheel driving force distribution unit 20 and right and left axles 22R, 22L. In the two-wheel drive mode, at least a first intermeshing clutch (intermeshing clutch) 24 provided in a transfer 26 is released, and power is not transmitted to a propeller shaft (power transmission member) 28, a rear wheel driving force distribution unit 30, or the rear wheels 16. However, in a four-wheel drive mode, in addition to the two-wheel drive mode, both the first intermeshing clutch 24 and a second intermeshing clutch (intermeshing clutch) 32 are engaged, and driving force from the engine 12 is transmitted to the propeller shaft 28, the rear wheel driving force distribution unit 30 and the rear wheels 16. Although not shown in FIG. 1, a torque converter, which is a fluid transmission device, or a clutch is provided between the engine 12 and the automatic transmission 18.

The front wheel driving force distribution unit 20 includes a ring gear 20r, a differential case 20c and a differential gear mechanism 20d. The ring gear 20r is provided so as to be rotatable around a first rotation axis (first axis) C1, and is in mesh with an output gear 18a of the automatic transmission 18. The differential case 20c is fixed to the ring gear 20r. The differential gear mechanism 20d is accommodated in the differential case 20c. The front wheel driving force distribution unit 20 transmits driving force to the right and left axles 22R, 22L of the front wheels 14 while allowing differential rotation between the axles 22R, 22L. The differential case 20c has internal teeth 20a. The internal teeth 20a are fitted to first outer peripheral spline teeth 34a. The first outer peripheral spline teeth 34a are provided at the axial end of an input shaft (first input rotating member) 34 provided in the transfer 26. Thus, part of driving force that is transmitted from the engine 12 to the right and left front wheels 14R, 14L via the differential case 20c is input to the transfer 26 via the input shaft 34.

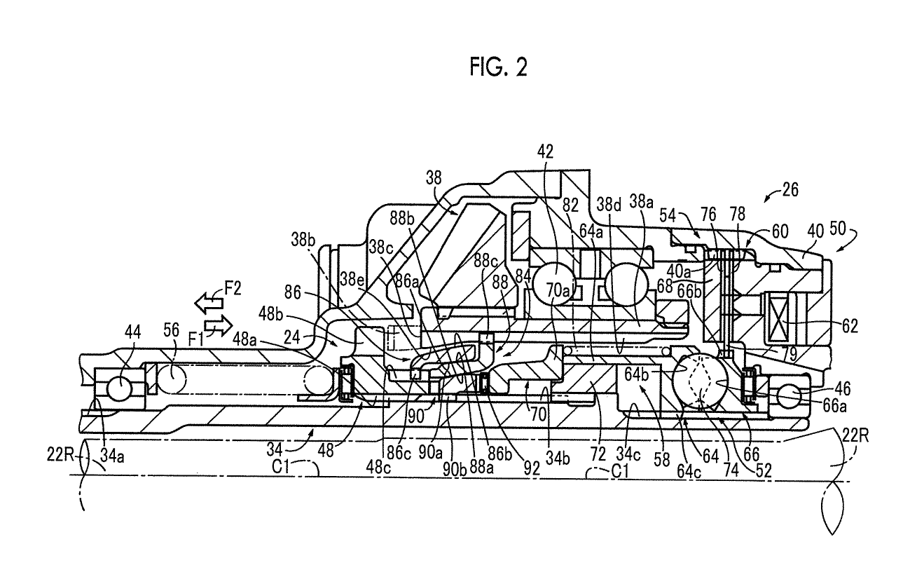

As shown in FIG. 1 and FIG. 2, the transfer 26 includes a cylindrical first ring gear (first output rotating member) 38, the cylindrical input shaft 34, and the first intermeshing clutch 24. The first ring gear (first output rotating member) 38 is in mesh with a driven pinion 36 for transmission of power. The driven pinion 36 is coupled to one end of the propeller shaft 28 in order to drive the propeller shaft 28. Part of power that is transmitted from the engine 12 to the front wheels 14R, 14L via the differential case 20c is input to the cylindrical input shaft 34. The first intermeshing clutch 24 connects the differential case 20c to the propeller shaft 28 or disconnects the differential case 20c from the propeller shaft 28 in a power transmission path from the engine 12 to the propeller shaft 28. The differential case 20c is coupled to the engine 12 such that power is transmittable. That is, the first intermeshing clutch 24 connects the input shaft 34 to the first ring gear 38 or disconnects the input shaft 34 from the first ring gear 38. The input shaft 34 is coupled to the differential case 20c. The first ring gear 38 is coupled to the propeller shaft 28. When the first intermeshing clutch 24 is engaged and the power transmission path between the input shaft 34 and the first ring gear 38 is connected, part of driving force that is transmitted from the engine 12 to the right and left front wheels 14R, 14L is output to the right and left rear wheels 16R, 16L via the propeller shaft 28.

As shown in FIG. 2, the cylindrical first ring gear 38 is, for example, a bevel gear having helical gear teeth or hypoid gear teeth, and includes a shaft portion 38a that protrudes in substantially a cylindrical shape from the inner peripheral portion of the first ring gear 38 toward the front wheel 14R side. The shaft portion 38a of the cylindrical first ring gear 38 is supported by a bearing 42 provided in a first unit case 40, so the first ring gear 38 is supported in a cantilever manner so as to be rotatable around the first rotation axis C1. As shown in FIG. 1, the first ring gear 38 is coupled to the rear wheels 16R, 16L via the second intermeshing clutch 32, the propeller shaft 28, the driven pinion 36, and the like, and rotates around the first rotation axis C1 around which the input shaft 34 rotates.

As shown in FIG. 2, the cylindrical input shaft 34 extends through the inside of the cylindrical first ring gear 38, and part of the input shaft 34 is arranged inside the first ring gear 38. The cylindrical input shaft 34 is supported at both ends by a pair of bearings 44, 46 provided inside the first unit case 40. Thus, the input shaft 34 is supported so as to be rotatable around the first rotation axis C1, that is, the input shaft 34 is supported so as to be rotatable concentrically with the first ring gear 38. The cylindrical input shaft 34 integrally includes the first outer peripheral spline teeth 34a, second outer peripheral spline teeth 34b and third outer peripheral spline teeth 34c. The first outer peripheral spline teeth 34a are provided on the outer periphery at the front wheel 14L-side end of the input shaft 34. The second outer peripheral spline teeth 34b are provided on the outer periphery at the center of the input shaft 34. The third outer peripheral spline teeth 34c are provided on the outer periphery at the front wheel 14R-side end of the input shaft 34.

The first intermeshing clutch 24 is a separating mechanism (dog clutch) for connecting or interrupting the power transmission path between the engine 12 and the propeller shaft 28 in the transfer 26. That is, the first intermeshing clutch 24 is a separating mechanism for connecting or interrupting the power transmission path between the input shaft 34 and the first ring gear 38. The input shaft 34 is coupled to the engine 12 such that power is transmittable. The first ring gear 38 is coupled to the propeller shaft 28 such that power is transmittable. The first intermeshing clutch 24 includes a first movable sleeve (first sleeve) 48 and a first actuating mechanism 50. The first movable sleeve (first sleeve) 48 is spline-fitted to the input shaft 34, and moves in the direction of the first rotation axis C1 to selectively mesh with the first ring gear 38. The first actuating mechanism 50 moves the first movable sleeve 48 in the direction of the first rotation axis C1 so as to move the first movable sleeve 48 between a first connection position and a first disconnection position. The first connection position is a position at which the first intermeshing clutch 24 is engaged. The first disconnection position is a position at which the first intermeshing clutch 24 is released. The first movable sleeve 48 has spline grooves 48a and external teeth 48b. The spline grooves 48a are provided on the inner periphery of the first movable sleeve 48 such that the second outer peripheral spline teeth 34b of the input shaft 34 are fitted to the spline grooves 48a. The external teeth 48b are provided on the outer periphery of the first movable sleeve 48. When the second outer peripheral spline teeth 34b of the input shaft 34 are fitted to the spline grooves 48a of the first movable sleeve 48, the first movable sleeve 48 is supported by the input shaft 34 so as to be relatively non-rotatable with respect to the input shaft 34 and movable in the direction of the first rotation axis C1. That is, when the first movable sleeve 48 is spline-fitted to the input shaft 34, the first movable sleeve 48 is supported by the input shaft 34 so as to be relatively non-rotatable and movable in the direction of the first rotation axis C1 with respect to the input shaft 34. The first ring gear 38 has teeth 38b provided on a front wheel 14L-side side face 38c of the shaft portion 38a of the first ring gear 38. The first connection position is a position at which the external teeth 48b of the first movable sleeve 48 mesh with the teeth 38b of the first ring gear 38 as a result of movement of the first movable sleeve 48 in the direction of the first rotation axis C1. At the first connection position, relative rotation between the first ring gear 38 and the input shaft 34 is not allowed. The first disconnection position is a position at which the external teeth 48b of the first movable sleeve 48 do not mesh with the teeth 38b of the first ring gear 38 as a result of movement of the first movable sleeve 48 in the direction of the first rotation axis C1. At the first disconnection position, relative rotation between the first ring gear 38 and the input shaft 34 is allowed.

The first actuating mechanism 50 includes a first ball cam 52, a first actuator 54, a first spring 56 and a first ratchet mechanism (first latch mechanism) 58. The first actuator 54 includes a first auxiliary clutch 60 and a first electromagnetic coil 62. The first electromagnetic coil 62 generates rotational braking torque in the first auxiliary clutch 60. The first actuator 54 is integrally fixed to the first unit case 40. The first ball cam 52 is a device that converts the rotational force of the input shaft 34 to thrust in the direction of the first rotation axis C1 as rotational braking torque is generated by the first actuator 54 in an annular second annular member 66 (described later) via the first auxiliary clutch 60. The first ratchet mechanism 58 moves the first movable sleeve 48 by using thrust converted by the first ball cam 52, and retains the moved position of the first movable sleeve 48. The first spring 56 is interposed between the first movable sleeve 48 and the front wheel 14L-side bearing 44 that is one of the pair of bearings 44, 46. The first spring 56 urges the first movable sleeve 48 from the first disconnection position toward the first connection position. That is, the first spring 56 urges the first movable sleeve 48 in a meshing direction F1 in the direction of the first rotation axis C1. The first movable sleeve 48 meshes with the first ring gear 38 when moved in the meshing direction F1. Thus, the first actuating mechanism 50 generates thrust in the direction of the first rotation axis C1 in the first ball cam 52 by exerting rotational braking torque to the second annular member 66 with the use of the first electromagnetic coil 62 and first auxiliary clutch 60 of the first actuator 54. The first actuating mechanism 50 moves the first movable sleeve 48 via the first ratchet mechanism 58 with the use of a first annular member 64 (described later) in the direction of the first rotation axis C1 against the urging force of the first spring 56.

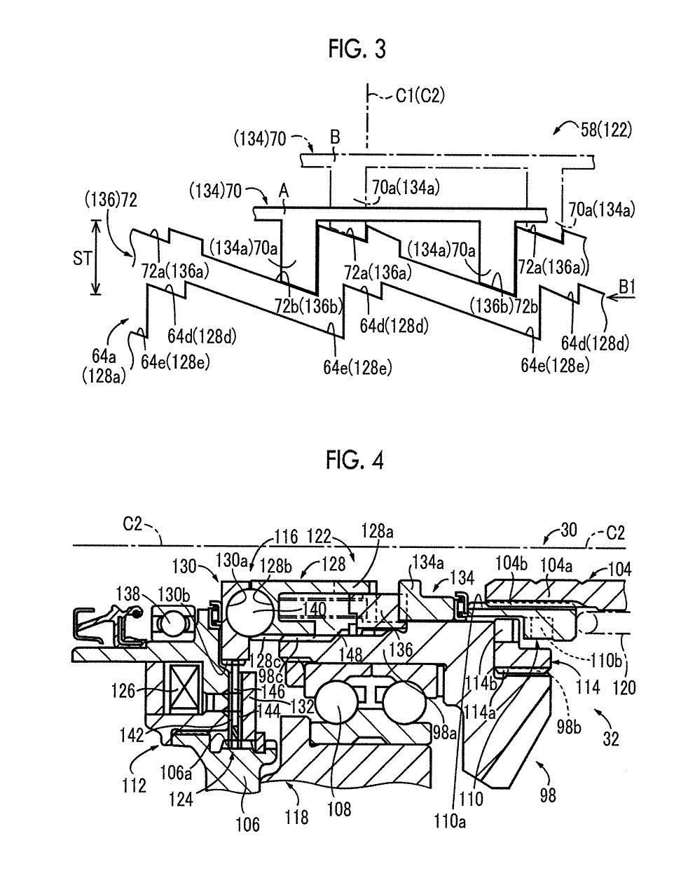

The first ratchet mechanism 58 includes an annular first piston 64a, an annular second piston 70 and an annular first holder 72. When the first electromagnetic coil 62 attracts a disc-shaped movable piece 68 in the first actuator 54, the first piston 64a is reciprocated in the direction of the first rotation axis C1 by a predetermined stroke ST (see FIG. 3) via the first ball cam 52. The second piston 70 is provided so as to be relatively rotatable with respect to the input shaft 34, and is moved by the first piston 64a in the direction of the first rotation axis C1 against the urging force of the first spring 56. The first holder 72 has latch teeth 72a (see FIG. 3). The first holder 72 is provided so as to be relatively non-rotatable with respect to the input shaft 34 and non-movable in the direction of the first rotation axis C1. The first holder 72 latches the second piston 70, moved by the first piston 64a, with the latch teeth 72a. In the first ratchet mechanism 58, when the first piston 64a is reciprocated in the direction of the first rotation axis C1, the first movable sleeve 48 is moved to the first disconnection position by the second piston 70. At this time, the first movable sleeve 48 is moved against the urging force of the first spring 56. The second piston 70 is latched onto the latch teeth 72a of the first holder 72. In addition, as the first piston 64a is reciprocated again in the direction of the first rotation axis C1, the second piston 70 is unlatched from the latch teeth 72a of the first holder 72. The first movable sleeve 48 is moved to the first connection position under the urging force of the first spring 56. As shown in FIG. 2, the first annular member 64 of the first ball cam 52 integrally includes the first piston 64a of the first ratchet mechanism 58. The first ratchet mechanism 58 is arranged between the first movable sleeve 48 and the second annular member 66 of the first ball cam 52.

The first ball cam 52 includes the pair of annular first annular member 64 and annular second annular member 66 and a plurality of (for example, three) spherical rolling elements 74 between the bearing 46 and the second piston 70 of the first ratchet mechanism 58. The first annular member 64 and the second annular member 66 are interposed so as to overlap with each other in the direction of the first rotation axis C1. Each of the spherical rolling elements 74 is sandwiched by a pair of mutually facing concave cam faces 64b, 66a. The cam faces 64b, 66a are respectively provided in the first annular member 64 and the second annular member 66 at multiple portions (for example, three portions) in the circumferential direction, and the depth of each of the cam faces 64b, 66a varies in the circumferential direction. As the first annular member 64 and the second annular member 66 are relatively rotated, the first annular member 64 and the second annular member 66 are distanced from each other in the direction of the first rotation axis C1. Thus, as the first piston 64a is reciprocated once by the first ball cam 52 toward the front wheel 14L side and the front wheel 14R side in the direction of the first rotation axis C1, the first movable sleeve 48 is moved to the first disconnection position. That is, as shown in FIG. 2, the first movable sleeve 48 is moved via the first ratchet mechanism 58 to the first disconnection position against the urging force of the first spring 56. Meshing of the external teeth 48b of the first movable sleeve 48 with the teeth 38b of the first ring gear 38 is released, with the result that the first intermeshing clutch 24 is released. As the first piston 64a is reciprocated twice by the first ball cam 52, that is, as the first piston 64a is further reciprocated once in a state where the first movable sleeve 48 is placed at the first disconnection position, the first movable sleeve 48 is moved to the first connection position. That is, although not shown in the drawing, the second piston 70 is unlatched from the latch teeth 72a of the first holder 72, and the first movable sleeve 48 is moved to the first connection position under the urging force of the first spring 56. The external teeth 48b of the first movable sleeve 48 are meshed with the teeth 38b of the first ring gear 38, with the result that the first intermeshing clutch 24 is engaged. The concave cam faces 64b, 66a provided at multiple portions in the circumferential direction between the annular first annular member 64 and the annular second annular member 66 are inclined such that the distance in the direction of the first rotation axis C1 between those cam faces 64b, 66a shortens as portions of the cam faces 64b, 66a shift in the circumferential direction. The internal teeth 64c are provided on the inner periphery of the first annular member 64. The internal teeth 64c are in mesh with the third outer peripheral spline teeth 34c of the input shaft 34 so as to be relatively non-rotatable and movable in the direction of the first rotation axis C1.

As shown in FIG. 2, the first auxiliary clutch 60 is arranged between the first electromagnetic coil 62 and the movable piece 68 in the first actuator 54. The first auxiliary clutch 60 includes a pair of disc-shaped first friction plates 76, 78 and a disc-shaped second friction plate 79. The pair of first friction plates 76, 78 are engaged with inner peripheral spline teeth 40a so as to be non-rotatable around the first rotation axis C1 and movable in the direction of the first rotation axis C1. The inner peripheral spline teeth 40a are provided in the first unit case 40. The second friction plate 79 is arranged between the pair of first friction plates 76, 78. The second friction plate 79 is engaged with outer peripheral spline teeth 66b so as to be non-rotatable around the first rotation axis C1 and movable in the direction of the first rotation axis C1. The outer peripheral spline teeth 66b are provided in the second annular member 66.

In the thus configured first actuator 54 and first ball cam 52, for example, in a state where the input shaft 34 is rotating while the vehicle is traveling, as a first electromagnetic coil current I₁ is supplied from an electronic control unit 80 to the first electromagnetic coil 62, the movable piece 68 is attracted by the first electromagnetic coil 62. For this reason, the first friction plates 76, 78 and second friction plate 79 of the first auxiliary clutch 60 are clamped between the movable piece 68 and the first electromagnetic coil 62, and rotational braking torque is transmitted to the second friction plate 79. That is, as the movable piece 68 is attracted by the first electromagnetic coil 62, rotational braking torque is transmitted to the second annular member 66 via the second friction plate 79. For this reason, the rotational braking torque is transmitted to the second annular member 66, with the result that the first annular member 64 and the second annular member 66 relatively rotate. The first piston 64a integrally provided in the first annular member 64 moves toward the front wheel 14L side, and the rotational force of the input shaft 34 is converted to thrust in the direction of the first rotation axis C1. At this time, the first piston 64a runs against the urging force of the first spring 56 via the spherical rolling elements 74 in the direction of the first rotation axis C1 with respect to the second annular member 66. When supply of the first electromagnetic coil current I₁ from the electronic control unit 80 to the first electromagnetic coil 62 is stopped and the movable piece 68 is not attracted by the first electromagnetic coil 62, the first piston 64a moves toward the front wheel 14R side, so the first annular member 64 and the second annular member 66 integrally rotate. That is, the first annular member 64 moves toward the front wheel 14R side in the direction of the first rotation axis C1 under the urging force of a spring 82 provided in the first ratchet mechanism 58. The first annular member 64 co-rotates with the second annular member 66 via the spherical rolling elements 74. For this reason, the first annular member 64 and the second annular member 66 integrally rotate.

FIG. 3 is a schematic view that illustrates the operation principle of an example of the first ratchet mechanism 58, and shows a developed state of each of the annular first piston 64a, the annular second piston 70 and the annular first holder 72. The first ratchet mechanism 58 functions as a latch mechanism for latching the second piston 70 onto the first holder 72 and an unlatch mechanism for unlatching the second piston 70 from the first holder 72. The first holder 72 has latch teeth 72a, 72b in which multi-step sawteeth continuous in the circumferential direction are periodically provided. The latch teeth 72a, 72b are provided in order to latch protrusions 70a protruding from the second piston 70 toward the first holder 72 side. The first holder 72 is provided on the input shaft 34 so as to be fixed in position. The first piston 64a has receiving teeth 64d, 64e continuous in the circumferential direction in a similar sawtooth shape to those of the latch teeth 72a, 72b of the first holder 72 but shifted by a half phase in the circumferential direction. The receiving teeth 64d, 64e are periodically provided. The receiving teeth 64d, 64e are provided in order to receive the protrusions 70a of the second piston 70. The first piston 64a is provided so as to be relatively non-rotatable with respect to the input shaft 34, that is, the first holder 72, and relatively movable in the direction of the first rotation axis C1. The two latch teeth 72a, 72b of the first holder 72, having different heights, are provided so as to approach the second piston 70 within a distance shorter than or equal to the stroke ST of the first piston 64a that is moved by the first actuator 54 and the first ball cam 52. In addition, the two receiving teeth 64d, 64e of the first piston 64a, having different heights, are provided in a similar shape to those of the latch teeth 72a, 72b, and are located so as to be shifted by a half phase in the circumferential direction with respect to the latch teeth 72a, 72b. In FIG. 3, for the sake of easy understanding, the first piston 64a and the first holder 72 are intentionally shifted in the direction of the first rotation axis C1 and are shown; however, in an initial state, the inclined face of each of the receiving teeth 64e is caused to substantially coincide with the inclined face of any one of the latch teeth 72b. The stroke ST of the first piston 64a is indicated as a stroke from a base position B1 that is the lower end of the inclined face of each of the latch teeth 72b of the first holder 72 fixed in position.

As shown in FIG. 3, a state where the protrusions 70a of the second piston 70 are located at a position A is referred to as initial state. At the position A, the protrusions 70a are latched onto the latch teeth 72b of the first holder 72 at the time when the first movable sleeve 48 is placed at the first connection position. In the initial state, as the first piston 64a is reciprocated by the first actuator 54 and the first ball cam 52 for the first time, the protrusions 70a of the second piston 70 are raised by the receiving teeth 64e of the first piston 64a. The protrusions 70a of the second piston 70 cross over the distal ends of the latch teeth 72a against the urging force of the first spring 56, slide onto the lowest ends of the inclined faces of the latch teeth 72a, and are latched at a position B. Subsequently, as the first piston 64a is reciprocated by the first actuator 54 and the first ball cam 52 for the second time, the protrusions 70a of the second piston 70 are raised by the receiving teeth 64d of the first piston 64a. The protrusions 70a of the second piston 70 cross over the distal ends of the latch teeth 72b of the first holder 72 against the urging force of the first spring 56, slide onto the lowest ends of the inclined faces of the latch teeth 72b, and are returned to the initial state. That is, as the first piston 64a is reciprocated by the first actuator 54 and the first ball cam 52 for the second time that corresponds to a predetermined number of times, the first movable sleeve 48 is returned to the first connection position. For this reason, the external teeth 48b of the first movable sleeve 48 are meshed with the teeth 38b of the first ring gear 38, and the first intermeshing clutch 24 is engaged.

Thus, in the first ratchet mechanism 58, by shifting the second piston 70 in the circumferential direction as a result of a reciprocation of the first piston 64a, the first movable sleeve 48 is moved to the first disconnection position, and the second piston 70 is latched onto the latch teeth 72a of the first holder 72. As the first piston 64a is further reciprocated, the second piston 70 is unlatched from the latch teeth 72a of the first holder 72, and the first movable sleeve 48 moves to the first connection position under the urging force of the first spring 56.

As shown in FIG. 2, the first intermeshing clutch 24 includes a synchromesh mechanism 84 arranged in series with the first movable sleeve 48 in the direction of the first rotation axis C1. At the time when the first movable sleeve 48 is moved by the first actuator 54 and the first ball cam 52 via the first ratchet mechanism 58 from the first disconnection position to the first connection position, the synchromesh mechanism 84 moves the first movable sleeve 48 in a non-meshing direction F2. The first movable sleeve 48 does not mesh with the first ring gear 38 when moved in the non-meshing direction F2. Thus, the first ring gear 38 and an outer ring 86 are in sliding contact with each other, and the outer ring 86, a middle ring 88 and an inner ring 90 are in sliding contact with each other, with the result that the rotation speed of the input shaft 34 is synchronized with the rotation speed of the first ring gear 38.

As shown in FIG. 2, the annular middle ring 88 includes a conical outer peripheral friction face 88a, a conical inner peripheral friction face 88b and outer peripheral spline teeth 88c. The conical outer peripheral friction face 88a is slidable on the conical inner peripheral friction face 86a provided on the inner periphery of the outer ring 86 and inclined with respect to the first rotation axis C1. The conical inner peripheral friction face 88b is slidable on a conical outer peripheral friction face 90a provided on the outer periphery of the inner ring 90 and inclined with respect to the first rotation axis C1. The outer peripheral spline teeth 88c are provided on the outer periphery of an end of the middle ring 88 at the other side of the middle ring 88 with respect to the first movable sleeve 48 side. The middle ring 88 is provided on the first ring gear 38. The outer peripheral spline teeth 88c of the middle ring 88 are fitted to spline grooves 38d provided on the inner periphery of the shaft portion 38a of the first ring gear 38, so the middle ring 88 is relatively non-rotatable with respect to the first ring gear 38 and movable in the direction of the first rotation axis C1.

As shown in FIG. 2, the annular outer ring 86 includes a conical inner peripheral friction face 86a, a conical outer peripheral friction face 86b and inner peripheral spline teeth 86c. The conical outer peripheral friction face 86b is slidable on the conical inner peripheral friction face 38e provided on the inner periphery of the first ring gear 38 and slightly inclined with respect to the first rotation axis C1. The inner peripheral spline teeth 86c are provided on the inner periphery of the first movable sleeve 48-side end of the outer ring 86. The outer ring 86 is provided on the input shaft 34 via the first movable sleeve 48. The inner peripheral spline teeth 86c of the outer ring 86 are fitted to spline grooves 48c provided on the outer periphery of the first movable sleeve 48, so the outer ring 86 is relatively non-rotatable with respect to the input shaft 34 and movable in the direction of the first rotation axis C1.

As shown in FIG. 2, the annular inner ring 90 includes the conical outer peripheral friction face 90a and spline grooves 90b. The spline grooves 90b are provided on the inner periphery of the inner ring 90. The inner ring 90 is provided on the input shaft 34. The second outer peripheral spline teeth 34b of the input shaft 34 are fitted to the spline grooves 90b of the inner ring 90, so the inner ring 90 is relatively non-rotatable with respect to the input shaft 34 and movable in the direction of the first rotation axis C1. An end of the inner ring 90 at the other side of the inner ring 90 with respect to the first movable sleeve 48 side is in contact with the second piston 70 via a thrust bearing 92. The first movable sleeve 48-side end of the inner ring 90 is in contact with the first movable sleeve 48.

For this reason, in the synchromesh mechanism 84, at the time when the first movable sleeve 48 is moved from the first disconnection position to the first connection position, the first movable sleeve 48 is moved in the non-meshing direction F2 by the inner ring 90 that is in contact with the second piston 70. Thus, the conical outer peripheral friction face 86b of the outer ring 86 is pressed against the conical inner peripheral friction face 38e of the first ring gear 38. Thus, the conical inner peripheral friction face 38e of the first ring gear 38 and the conical outer peripheral friction face 86b of the outer ring 86 are in sliding contact with each other, the conical inner peripheral friction face 86a of the outer ring 86 and the conical outer peripheral friction face 88a of the middle ring 88 are in sliding contact with each other, and the conical inner peripheral friction face 88b of the middle ring 88 and the conical outer peripheral friction face 90a of the inner ring 90 are in sliding contact with each other, so the rotation speed of the first ring gear 38 and the rotation speed of the input shaft 34 synchronize with each other.

As shown in FIG. 1 and FIG. 4, the rear wheel driving force distribution unit 30 includes a cylindrical second ring gear (second output rotating member) 98, a differential case (second input rotating member) 104 of a differential gear unit 102, and the second intermeshing clutch 32. The cylindrical second ring gear 98 is provided in the power transmission path between the propeller shaft 28 and each of the rear wheels 16R, 16L. The cylindrical second ring gear 98 is engaged with a drive pinion 96 so as to be relatively non-rotatable. The drive pinion 96 is coupled to one end of the propeller shaft 28 via a coupling 94. The differential case 104 of the differential gear unit 102 is provided in the power transmission path between the propeller shaft 28 and each of the rear wheels 16R, 16L. The differential case 104 is coupled to the rear wheels 16R, 16L via axles 100R, 100L. The second intermeshing clutch 32 is an intermeshing dog clutch (separating device) that connects the propeller shaft 28 to the right and left rear wheels 16R, 16L or disconnects the propeller shaft 28 from the right and left rear wheels 16R, 16L. That is, the second intermeshing clutch 32 is an intermeshing dog clutch that connects the second ring gear 98, which is in mesh with the drive pinion 96 so as to be relatively non-rotatable, to the differential case 104 or disconnects the second ring gear 98 from the drive pinion 96. The coupling 94 is provided in the power transmission path between the propeller shaft 28 and the second ring gear 98.

As shown in FIG. 1 and FIG. 4, the second ring gear 98 is, for example, a bevel gear having hypoid gear teeth, and includes a shaft portion 98a that protrudes in substantially a cylindrical shape from the inner peripheral portion of the second ring gear 98 toward the rear wheel 16L side. The shaft portion 98a of the cylindrical second ring gear 98 is supported by a bearing 108 provided in a second unit case 106, so the second ring gear 98 is supported in a cantilever manner so as to be rotatable around a second rotation axis (second axis) C2 around which the differential case 104 rotates. As shown in FIG. 1 and FIG. 4, the differential case 104 includes a cylindrical portion 104a that protrudes in substantially a cylindrical shape from the differential case 104 toward the rear wheel 16L side, that is, the inside of the cylindrical second ring gear 98. The distal end of the cylindrical portion 104a is arranged inside the cylindrical second ring gear 98. The differential case 104 is supported by a pair of bearings (not shown) provided inside the second unit case 106, so the cylindrical portion 104a, that is, the differential case 104, is supported so as to be rotatable around the second rotation axis C2, that is, concentrically with the second ring gear 98.

The second intermeshing clutch 32 is a separating mechanism (dog clutch) for connecting or interrupting the power transmission path between the propeller shaft 28 and the right and left rear wheels 16R, 16L in the rear wheel driving force distribution unit 30. That is, the second intermeshing clutch 32 is a dog clutch for connecting or interrupting the power transmission path between the second ring gear 98 and the differential case 104 of the differential gear unit 102. The second ring gear 98 is coupled to the propeller shaft 28 such that power is transmittable. The differential case 104 is coupled to the rear wheels 16R, 16L such that power is transmittable. The second intermeshing clutch 32 includes a second movable sleeve (second sleeve) 110 and a second actuating mechanism 112. The second movable sleeve 110 is spline-fitted to the cylindrical portion 104a of the differential case 104, and moves in the direction of the second rotation axis C2 to selectively mesh with the second ring gear 98. The second actuating mechanism 112 moves the second movable sleeve 110 in the direction of the second rotation axis C2 to move the second movable sleeve 110 between a second connection position and a second disconnection position. The second connection position is a position at which the second intermeshing clutch 32 is engaged. The second disconnection position is a position at which the second intermeshing clutch 32 is released. The second movable sleeve 110 has spline grooves 110a and external teeth 110b. The spline grooves 110a are provided on the inner periphery of the second movable sleeve 110 such that outer peripheral spline teeth 104b are fitted to the spline grooves 110a. The outer peripheral spline teeth 104b are provided at the distal end of the cylindrical portion 104a of the differential case 104. The external teeth 110b are provided on the outer periphery of the second movable sleeve 110. When the outer peripheral spline teeth 104b of the cylindrical portion 104a of the differential case 104 are fitted to the spline grooves 110a of the second movable sleeve 110, the second movable sleeve 110 is supported by the cylindrical portion 104a of the differential case 104 so as to be relatively non-rotatable with respect to the differential case 104 and movable in the direction of the second rotation axis C2. That is, when the second movable sleeve 110 is spline-fitted to the cylindrical portion 104a of the differential case 104, the second movable sleeve 110 is supported by the cylindrical portion 104a of the differential case 104 so as to be relatively non-rotatable with respect to the differential case 104 and movable in the direction of the second rotation axis C2. The second ring gear 98 includes internal teeth 98b, an annular member 114, and internal teeth 114b. The internal teeth 98b are provided on the inner periphery of the rear wheel 16R-side end of the second ring gear 98. The annular member 114 has external teeth 114a that mesh with the internal teeth 98b. The internal teeth 114b can mesh with the external teeth 110b of the second movable sleeve 110. The internal teeth 114b are provided on the inner periphery of the annular member 114. The second connection position is a position at which the external teeth 110b of the second movable sleeve 110 mesh with the internal teeth 98b of the second ring gear 98 via the annular member 114 as a result of movement of the second movable sleeve 110 in the direction of the second rotation axis C2. At the second connection position, relative rotation between the second ring gear 98 and the differential case 104 is not allowed. The second disconnection position is a position at which the external teeth 110b of the second movable sleeve 110 do not in mesh with the internal teeth 98b of the second ring gear 98 via the annular member 114 as a result of movement of the second movable sleeve 110 in the direction of the second rotation axis C2. At the second disconnection position, relative rotation between the second ring gear 98 and the differential case 104 is allowed. In the second intermeshing clutch 32, in the two-wheel drive mode in which the first intermeshing clutch 24 is released, as shown in FIG. 1, as the second movable sleeve 110 is moved by the second actuating mechanism 112 to the second disconnection position, the propeller shaft 28 is released from each of the rear wheels 16R, 16L. That is, the second ring gear 98 is released from the differential case 104. Thus, the propeller shaft 28 is disconnected from the right and left rear wheels 16R, 16L, so the running resistance of the vehicle due to the rotational resistance of the propeller shaft 28, and the like, is reduced. The four-wheel drive vehicle 10 according to the present embodiment is a four-wheel drive vehicle with a disconnection function, and disconnects the propeller shaft 28, which is used to exclusively transmit driving force to the rear wheels 16 in the four-wheel drive mode, from the engine 12 and the rear wheels 16 in the two-wheel drive mode.

The second actuating mechanism 112 includes a second ball cam 116, a second actuator 118, a second spring 120 and a second ratchet mechanism (second latch mechanism) 122. The second actuator 118 includes a second auxiliary clutch 124 and a second electromagnetic coil 126. The second electromagnetic coil 126 generates rotational braking torque in the second auxiliary clutch 124. The second actuator 118 is integrally fixed to the second unit case 106. The second ball cam 116 is a device that converts the rotational force of the second ring gear 98 to thrust in the direction of the second rotation axis C2 as rotational braking torque is generated in an annular fourth annular member 130 (described later). The rotational force of the second ring gear 98 is transmitted to an annular third annular member 128 (described later). The second ball cam 116 generates rotational braking torque in the annular fourth annular member 130 via the second auxiliary clutch 124 with the use of the second actuator 118. The second ratchet mechanism 122 moves the second movable sleeve 110 by using thrust converted by the second ball cam 116 against the urging force of the second spring 120, and retains the moved position of the second movable sleeve 110. The second spring 120 is interposed between the differential case 104 and the second movable sleeve 110. The second spring 120 urges the second movable sleeve 110 from the second disconnection position toward the second connection position. That is, the second movable sleeve 110 is urged toward the rear wheel 16L side in the direction of the second rotation axis C2. Thus, the second actuating mechanism 112 exerts rotational braking torque to the fourth annular member 130 with the use of the second electromagnetic coil 126 and second auxiliary clutch 124 of the second actuator 118. The second actuating mechanism 112 generates thrust in the direction of the second rotation axis C2 in the second ball cam 116, and moves the second movable sleeve 110 with the use of the third annular member 128 via the second ratchet mechanism 122 in the direction of the second rotation axis C2 against the urging force of the second spring 120.

The second ratchet mechanism 122 includes an annular third piston 128a, an annular fourth piston 134 and an annular second holder 136. When the second electromagnetic coil 126 attracts a disc-shaped movable piece 132 in the second actuator 118, the annular third piston 128a is reciprocated in the direction of the second rotation axis C2 by the predetermined stroke ST (see FIG. 3) via the second ball cam 116. The annular fourth piston 134 is provided so as to be relatively rotatable with respect to the second ring gear 98, and is moved by the third piston 128a in the direction of the second rotation axis C2 against the urging force of the second spring 120. The annular second holder 136 has latch teeth 136a (see FIG. 3). The second holder 136 is provided so as to be relatively non-rotatable with respect to the second ring gear 98 and non-movable in the direction of the second rotation axis C2. The second holder 136 latches the fourth piston 134, moved by the third piston 128a, with the latch teeth 136a. In the second ratchet mechanism 122, when the third piston 128a is reciprocated in the direction of the second rotation axis C2, the second movable sleeve 110 is moved to the second disconnection position by the fourth piston 134 against the urging force of the second spring 120. The fourth piston 134 is latched onto the latch teeth 136a of the second holder 136. As the third piston 128a is reciprocated in the direction of the second rotation axis C2, the fourth piston 134 is unlatched from the latch teeth 136a of the second holder 136, and the second movable sleeve 110 is moved to the second connection position under the urging force of the second spring 120. As shown in FIG. 4, the third annular member 128 of the second ball cam 116 integrally includes the third piston 128a of the second ratchet mechanism 122. The second ratchet mechanism 122 is arranged between the second movable sleeve 110 and the fourth annular member 130 of the second ball cam 116.

The second ball cam 116 includes the pair of annular third annular member 128 and annular fourth annular member 130 and a plurality of (for example, three) spherical rolling elements 140 between a bearing 138 and the fourth piston 134 of the second ratchet mechanism 122. The third annular member 128 and the fourth annular member 130 are interposed so as to overlap with each other in the direction of the second rotation axis C2. Each of the spherical rolling elements 140 is sandwiched by a pair of mutually facing concave cam faces 128b, 130a. The cam faces 128b, 130a are respectively provided in the third annular member 128 and the fourth annular member 130 at multiple portions (for example, three portions) in the circumferential direction, and the depth of each of the cam faces 128b, 130a varies in the circumferential direction. As the third annular member 128 and the fourth annular member 130 are relatively rotated, the third annular member 128 and the fourth annular member 130 are distanced from each other in the direction of the second rotation axis C2. Thus, as the third piston 128a is reciprocated once by the second ball cam 116 toward the rear wheel 16R side and the rear wheel 16L side in the direction of the second rotation axis C2, the second movable sleeve 110 is moved via the second ratchet mechanism 122 to the second disconnection position against the urging force of the second spring 120 as shown in FIG. 4. Meshing of the external teeth 110b of the second movable sleeve 110 with the internal teeth 114b of the annular member 114 is released, with the result that the second intermeshing clutch 32 is released. As the third piston 128a is reciprocated twice by the second ball cam 116, the fourth piston 134 is unlatched from the latch teeth 136a of the second holder 136, and the second movable sleeve 110 is moved to the second connection position under the urging force of the second spring 120 although not shown in the drawing. That is, as the third piston 128a is further reciprocated once in a state where the second movable sleeve 110 is arranged at the second disconnection position, the fourth piston 134 is unlatched from the latch teeth 136a of the second holder 136, and the second movable sleeve 110 is moved to the second connection position under the urging force of the second spring 120 although not shown in the drawing. The external teeth 110b of the second movable sleeve 110 are meshed with the internal teeth 114b of the annular member 114, with the result that the second intermeshing clutch 32 is engaged. The concave cam faces 128b, 130a provided at multiple portions in the circumferential direction between the annular third annular member 128 and the annular fourth annular member 130 are inclined such that the distance in the direction of the second rotation axis C2 between those cam faces 128b, 130a shortens as portions of the cam faces 128b, 130a shift in the circumferential direction. External teeth 128c are provided on the outer periphery of the third annular member 128. The external teeth 128c mesh with spline teeth 98c so as to be relatively non-rotatable and movable in the direction of the second rotation axis C2. The spline teeth 98c are provided on the inner periphery of an end of the shaft portion 98a of the second ring gear 98 at the other side of the shaft portion 98a with respect to the second movable sleeve 110 side.

As shown in FIG. 4, the second auxiliary clutch 124 is arranged between the second electromagnetic coil 126 and the movable piece 132 in the second actuator 118. The second auxiliary clutch 124 includes a pair of disc-shaped third friction plates 142, 144 and a disc-shaped fourth friction plate 146. The third friction plates 142, 144 are engaged with inner peripheral spline teeth 106a so as to be non-rotatable around the second rotation axis C2 and movable in the C2 direction of the second rotation axis C2. The inner peripheral spline teeth 106a are provided in the second unit case 106. The fourth friction plate 146 is arranged between the pair of third friction plates 142, 144. The fourth friction plate 146 is engaged with outer peripheral spline teeth 130b so as to be non-rotatable around the second rotation axis C2 and movable in the direction of the second rotation axis C2. The outer peripheral spline teeth 130b are provided in the second annular member 130.

In the thus configured second actuator 118 and second ball cam 116, for example, in a state where the second ring gear 98 is rotating while the vehicle is traveling, as a second electromagnetic coil current I₂ is supplied from the electronic control unit 80 to the second electromagnetic coil 126, the movable piece 132 is attracted by the second electromagnetic coil 126. The third friction plates 142, 144 and fourth friction plate 146 of the second auxiliary clutch 124 are clamped between the movable piece 132 and the second electromagnetic coil 126, and rotational braking torque is transmitted to the fourth friction plate 146. That is, as the movable piece 132 is attracted by the second electromagnetic coil 126, rotational braking torque is transmitted to the fourth annular member 130 via the fourth friction plate 146. For this reason, when the rotational braking torque is transmitted to the fourth annular member 130, those third annular member 128 and fourth annular member 130 relatively rotate. The third piston 128a integrally formed with the third annular member 128 moves via the spherical rolling elements 140 toward the rear wheel 16R side against the urging force of the second spring 120 in the direction of the second rotation axis C2 with respect to the fourth annular member 130. Therefore, the rotational force of the second ring gear 98 is converted to thrust in the direction of the second rotation axis C2. When supply of the second electromagnetic coil current I₂ from the electronic control unit 80 to the second electromagnetic coil 126 is stopped and the movable piece 132 is not attracted by the second electromagnetic coil 126, the third piston 128a moves toward the rear wheel 16L side. That is, the third annular member 128 moves toward the rear wheel 16L side in the direction of the second rotation axis C2 under the urging force of a spring 148 provided in the second ratchet mechanism 122. The third annular member 128 co-rotates with the fourth annular member 130 via the spherical rolling elements 140, and the third annular member 128 and the fourth annular member 130 integrally rotate.

As described above, the second ratchet mechanism 122 includes the annular third piston 128a, the annular fourth piston 134 and the annular second holder 136. The second ratchet mechanism 122 functions as a latch mechanism for latching the fourth piston 134 onto the second holder 136 and an unlatch mechanism for unlatching the fourth piston 134 from the second holder 136. That is, the second ratchet mechanism 122 has a similar function to that of the above-described first ratchet mechanism 58. For this reason, in the present embodiment, the operation principle of the second ratchet mechanism 122 will be described with reference to FIG. 3 that illustrates the operation principle of the above-described first ratchet mechanism 58. As shown in FIG. 3, the second holder 136 has latch teeth 136a, 136b periodically. The latch teeth 136a, 136b are provided such that multi-step sawteeth are continuous in the circumferential direction. The multi-step sawteeth latch protrusions 134a protruded from the fourth piston 134 toward the second holder 136. The second holder 136 is provided on the second ring gear 98 so as to be fixedly positioned. The third piston 128a has receiving teeth 128d, 128e periodically. The receiving teeth 128d, 128e are continuous in the circumferential direction in a similar sawtooth shape to those of the latch teeth 136a, 136b of the second holder 136 but shifted by a half phase in the circumferential direction. The receiving teeth 128d, 128e receive the protrusions 134a of the fourth piston 134. The third piston 128a is provided so as to be relatively non-rotatable with respect to the second ring gear 98, that is, the second holder 136, and relatively movable in the direction of the second rotation axis C2. The two latch teeth 136a, 136b of the second holder 136, having different heights, are provided so as to approach the fourth piston 134 within a distance shorter than or equal to the stroke ST of the third piston 128a that is moved by the second actuator 118 and the second ball cam 116. In addition, the two receiving teeth 128d, 128e of the third piston 128a, having different heights, are provided in a similar shape to those of the latch teeth 136a, 136b, and are located so as to be shifted by a half phase in the circumferential direction with respect to the latch teeth 136a, 136b. In FIG. 3, for the sake of easy understanding, the third piston 128a and the second holder 136 are intentionally shifted in the direction of the second rotation axis C2 and are shown; however, in an initial state, the inclined face of each of the receiving teeth 128e is caused to substantially coincide with the inclined face of any one of the latch teeth 136b. The stroke ST of the third piston 128a is indicated as a stroke from the base position B1 that is the lower end of the inclined face of each of the latch teeth 136b of the second holder 136 fixed in position.

As shown in FIG. 3, a state where the protrusions 134a of the fourth piston 134 are located at the position A is referred to as initial state. At the position A, the protrusions 134a are latched onto the latch teeth 136b of the second holder 136 at the time when the second movable sleeve 110 is placed at the second connection position. In the initial state, as the third piston 128a is reciprocated by the second actuator 118 and the second ball cam 116 for the first time, the protrusions 134a of the fourth piston 134 are raised by the receiving teeth 128e of the third piston 128a. Thus, the protrusions 134a of the fourth piston 134 cross over the distal ends of the latch teeth 136a against the urging force of the second spring 120, slide onto the lowest ends of the inclined faces of the latch teeth 136a, and are latched at the position B. Subsequently, as the third piston 128a is reciprocated by the second actuator 118 and the second ball cam 116 for the second time, the protrusions 134a of the fourth piston 134 are raised by the receiving teeth 128d of the third piston 128a. Thus, the protrusions 134a of the fourth piston 134 cross over the distal ends of the latch teeth 136b of the second holder 136 against the urging force of the second spring 120, slide onto the lowest ends of the inclined faces of the latch teeth 136b, and are latched onto the latch teeth 136b. Thus, the protrusions 134a are returned to the initial state, that is, the position A. That is, as the third piston 128a is reciprocated by the second actuator 118 and the second ball cam 116 for the second time that corresponds to a predetermined number of times, the second movable sleeve 110 is returned to the second connection position. For this reason, the external teeth 110b of the second movable sleeve 110 are meshed with the internal teeth 114b of the annular member 114, with the result that the second intermeshing clutch 32 is engaged.

Thus, in the second ratchet mechanism 122, the fourth piston 134 is shifted in the circumferential direction as a result of a reciprocation of the third piston 128a, caused by the second actuator 118 and the second ball cam 116. Thus, the second movable sleeve 110 is moved to the second disconnection position, and the fourth piston 134 is latched onto the latch teeth 136a of the second holder 136. As the third piston 128a is further reciprocated, the fourth piston 134 is unlatched from the latch teeth 136a of the second holder 136. As a result, the second movable sleeve 110 moves to the second connection position under the urging force of the second spring 120.

With the thus configured four-wheel drive vehicle 10, for example, when a two-wheel drive traveling mode is selected by the electronic control unit 80 in the four-wheel drive mode in which both the first intermeshing clutch 24 and the second intermeshing clutch 32 are engaged, the first movable sleeve 48 is moved by the first actuating mechanism 50 from the first connection position to the first disconnection position in the transfer 26, and the first intermeshing clutch 24 is released. In addition, in the rear wheel driving force distribution unit 30, the second movable sleeve 110 is moved by the second actuating mechanism 112 from the second connection position to the second disconnection position. For this reason, the second intermeshing clutch 32 is released, and a disconnection state is established. In the disconnection state, the propeller shaft 28 is interrupted from transmission of power from the engine 12 that is a driving source and the rear wheels 16 that are the auxiliary drive wheels. When a four-wheel drive traveling mode is selected by the electronic control unit 80 in the disconnection state, the first movable sleeve 48 is moved by the first actuating mechanism 50 from the first disconnection position to the first connection position in the transfer 26, and the first intermeshing clutch 24 is engaged. In addition, in the rear wheel driving force distribution unit 30, the second movable sleeve 110 is moved by the second actuating mechanism 112 from the second disconnection position to the second connection position. For this reason, the second intermeshing clutch 32 is engaged, and the disconnection state is cancelled.

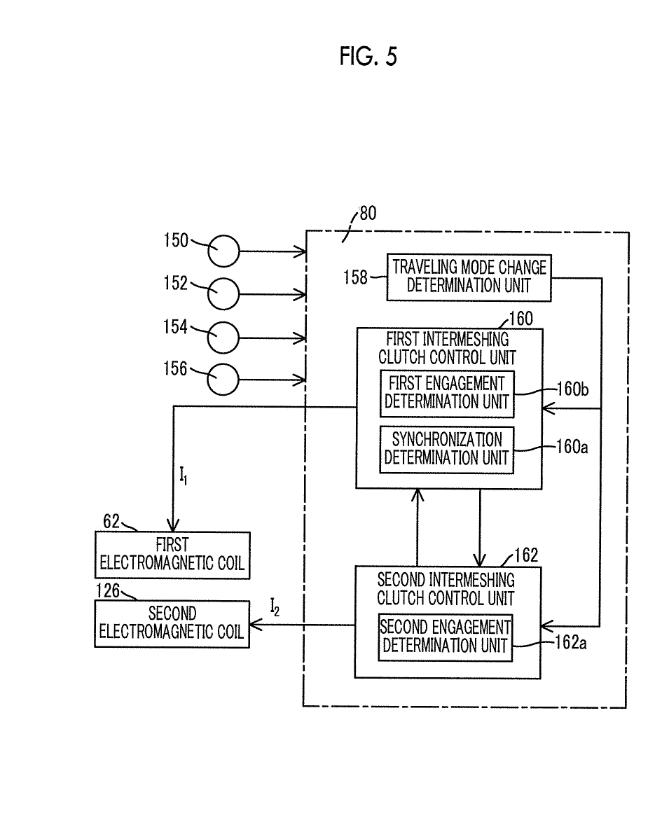

FIG. 5 is a functional block diagram that illustrates a relevant portion of control functions of the electronic control unit 80. As shown in FIG. 5, various input signals are detected by sensors provided in the four-wheel drive vehicle 10, and are supplied to the electronic control unit 80. For example, a signal indicating the rotation speed (propeller shaft rotation speed) N (rpm) of the propeller shaft 28, signals respectively indicating the rotation speeds Wfr, Wfl, Wrr, Wrl (rpm) of the front wheels 14R, 14L and rear wheels 16R, 16L, an on/off signal indicating whether the first intermeshing clutch 24 is engaged, that is, an on/off signal indicating whether the first movable sleeve 48 is placed at the first connection position, and an on/off signal indicating whether the second intermeshing clutch 32 is engaged, that is, an on/off signal indicating whether the second movable sleeve 110 is placed at the second connection position, are input to the electronic control unit 80. The signal indicating the propeller shaft rotation speed N (rpm) is detected by a rotation speed sensor 150. The signals respectively indicating the rotation speeds Wfr, Wfl, Wrr, Wrl (rpm) of the front wheels 14R, 14L and rear wheels 16R, 16L are detected by a wheel speed sensor 152. The on/off signal indicating whether the first intermeshing clutch 24 is engaged, that is, the on/off signal indicating whether the first movable sleeve 48 is placed at the first connection position, is detected by a first position sensor 154. The on/off signal indicating whether the second intermeshing clutch 32 is engaged, that is, the on/off signal indicating whether the second movable sleeve 110 is placed at the second connection position, is detected by a second position sensor 156. Each of the first position sensor 154 and the second position sensor 156 is, for example, a magnetic sensor that magnetically detects the proximity of the first movable sleeve 48 or the second movable sleeve 110 in a noncontact manner.

Various output signals are supplied from the electronic control unit 80 to devices provided in the four-wheel drive vehicle 10. For example, in order to engage the first intermeshing clutch 24, the first electromagnetic coil current I₁ is supplied from the electronic control unit 80 to the first electromagnetic coil 62 of the first actuator 54. In addition, in order to engage the second intermeshing clutch 32, the second electromagnetic coil current I₂ is supplied from the electronic control unit 80 to the second electromagnetic coil 126 of the second actuator 118.

A traveling mode change determination unit 158 shown in FIG. 5 determines whether to change the traveling mode from the two-wheel drive traveling mode to the four-wheel drive traveling mode. In the two-wheel drive traveling mode, the two-wheel drive mode is executed. In the two-wheel drive mode, driving force is transmitted from the engine 12 to the right and left front wheels 14R, 14L. In the four-wheel drive traveling mode, the four-wheel drive mode is executed. In the four-wheel drive mode, driving force is also transmitted from the engine 12 to the right and left rear wheels 16R, 16L. For example, when the traveling state of the four-wheel drive vehicle 10 satisfies any one of four-wheel drive start conditions, such as a start of traveling of the vehicle, a slip of at least one of the wheels, understeer, cornering, accelerating, high-load traveling and decelerating, the traveling mode change determination unit 158 determines whether to change the traveling mode from the two-wheel drive traveling mode to the four-wheel drive traveling mode. The two-wheel drive mode is a disconnection state where the first intermeshing clutch 24 and the second intermeshing clutch 32 are released and, as a result, the power transmission path between the engine 12 and the propeller shaft 28 and the power transmission path between the rear wheels 16 and the propeller shaft 28 are interrupted. In the disconnection state, the first movable sleeve 48 is placed at the first disconnection position, and the second movable sleeve 110 is placed at the second disconnection position. As shown in FIG. 5, the electronic control unit 80 includes the traveling mode change determination unit 158, a first intermeshing clutch control unit 160, a synchronization determination unit 160a, a first engagement determination unit 160b, a second intermeshing clutch control unit 162, and a second engagement determination unit 162a.

When the traveling mode change determination unit 158 determines to change the traveling mode from the two-wheel drive traveling mode to the four-wheel drive traveling mode, the first intermeshing clutch control unit 160 supplies the first electromagnetic coil current I₁ to the first electromagnetic coil 62 of the first actuator 54 in order to engage the first intermeshing clutch 24. As the first electromagnetic coil current I₁ is supplied to the first electromagnetic coil 62, the movable piece 68 is attracted by the first electromagnetic coil 62, and rotational braking torque is transmitted to the second annular member 66 of the first ball cam 52. Thus, the first annular member 64 and the second annular member 66 relatively rotate, and the first piston 64a integrally formed with the first annular member 64 moves the first movable sleeve 48 via the second piston 70 in the non-meshing direction F2 against the urging force of the first spring 56. As the first movable sleeve 48 is moved in the non-meshing direction F2, the synchromesh mechanism 84 is activated, so the rotation speed of the first ring gear 38 increases, and the rotation speed of the input shaft 34 and the rotation speed of the first ring gear 38 are synchronized with each other. When the traveling mode change determination unit 158 determines to change the traveling mode from the two-wheel drive traveling mode to the four-wheel drive traveling mode, the first intermeshing clutch control unit 160 engages the coupling 94.

When the traveling mode change determination unit 158 determines to change the traveling mode from the two-wheel drive traveling mode to the four-wheel drive traveling mode, the synchronization determination unit 160a determines whether the rotation speed of the first ring gear 38 has been synchronized with the rotation speed of the input shaft 34 in the first intermeshing clutch 24. That is, it is determined whether the rotation speed N (rpm) of the propeller shaft 28 coupled to the first ring gear 38 is higher than or equal to the rotation speed N₀ (rpm) of the differential case 20c coupled to the input shaft 34 (N≧N₀). The rotation speed N (rpm) of the propeller shaft 28 is detected by the rotation speed sensor 150. The rotation speed N₀ (rpm) of the differential case 20c is an average value ((Wfl+Wfr)÷2) of the rotation speeds Wfr, Wfl (rpm) of the front wheels 14R, 14L, detected by the wheel speed sensor 152.

When the traveling mode change determination unit 158 determines to change the traveling mode from the two-wheel drive traveling mode to the four-wheel drive traveling mode, the first engagement determination unit 160b determines whether the first intermeshing clutch 24 is engaged. That is, whether the first movable sleeve 48 of the first intermeshing clutch 24 is placed at the first connection position is determined on the basis of the on/off signal that is detected by the first position sensor 154. For example, the first position sensor 154 detects an on signal when the first movable sleeve 48 is placed at the first connection position. When the first movable sleeve 48 is placed at a position other than the first connection position (including the first disconnection position), the first position sensor 154 detects an off signal.

When the traveling mode change determination unit 158 determines to change the traveling mode from the two-wheel drive traveling mode to the four-wheel drive traveling mode, the second intermeshing clutch control unit 162 supplies the second electromagnetic coil current I₂ to the second electromagnetic coil 126 of the second actuator 118 in order to engage the second intermeshing clutch 32. As the second electromagnetic coil current I₂ is supplied to the second electromagnetic coil 126, the movable piece 132 is attracted by the second electromagnetic coil 126, and rotational braking torque is transmitted to the fourth annular member 130 of the second ball cam 116. Thus, for example, the synchromesh mechanism 84 is activated in the first intermeshing clutch 24, so the rotation speed of the first ring gear 38 increases, and the rotation speed of the second ring gear 98 increases via the propeller shaft 28. For this reason, the third annular member 128 and the fourth annular member 130 relatively rotate, the third piston 128a integrally formed with the third annular member 128 moves the second movable sleeve 110 via the fourth piston 134 toward the second spring 120 side against the urging force of the second spring 120.

When the traveling mode change determination unit 158 determines to change the traveling mode from the two-wheel drive traveling mode to the four-wheel drive traveling mode, the second engagement determination unit 162a determines whether the second intermeshing clutch 32 is engaged. That is, whether the second movable sleeve 110 of the second intermeshing clutch 32 is placed at the second connection position is determined on the basis of the on/off signal that is detected by the second position sensor 156. For example, the second position sensor 156 detects an on signal when the second movable sleeve 110 is placed at the second connection position. When the second movable sleeve 110 is placed at a position other than the second connection position (including the second disconnection position), the second position sensor 156 detects an off signal.

When the synchronization determination unit 160a determines that the rotation speed of the first ring gear 38 has been synchronized with the rotation speed of the input shaft 34 in the first intermeshing clutch 24, the second intermeshing clutch control unit 162 stops supply of the second electromagnetic coil current I₂ to the second electromagnetic coil 126. When supply of the second electromagnetic coil current I₂ is stopped in a state where the second electromagnetic coil current I₂ has been supplied to the second electromagnetic coil 126, the movable piece 132 is not attracted by the second electromagnetic coil 126. For this reason, thrust in the direction of the second rotation axis C2 for moving the second movable sleeve 110 toward the second spring 120 side against the urging force of the second spring 120 disappears from the third piston 128a integrally formed with the third annular member 128 of the second ball cam 116. Thus, the second movable sleeve 110 is moved to the second connection position under the urging force of the second spring 120, with the result that the second intermeshing clutch 32 is engaged.

When the second engagement determination unit 162a determines that the second intermeshing clutch 32 is engaged, the first intermeshing clutch control unit 160 stops supply of the first electromagnetic coil current I₁ to the first electromagnetic coil 62. When supply of the first electromagnetic coil current I₁ is stopped in a state where the first electromagnetic coil current I₁ has been supplied to the first electromagnetic coil 62, the movable piece 68 is not attracted by the first electromagnetic coil 62. For this reason, thrust in the direction of the first rotation axis C1 for moving the first movable sleeve 48 toward the first spring 56 side against the urging force of the first spring 56 disappears from the first piston 64a integrally formed with the first annular member 64 of the first ball cam 52. Thus, the first movable sleeve 48 is moved to the first connection position under the urging force of the first spring 56, and the first intermeshing clutch 24 is engaged.

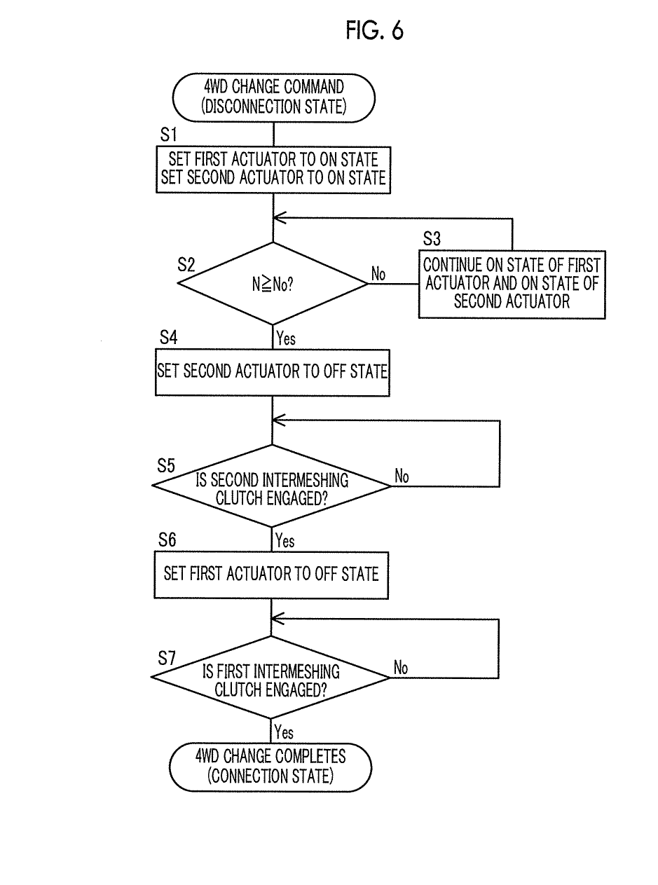

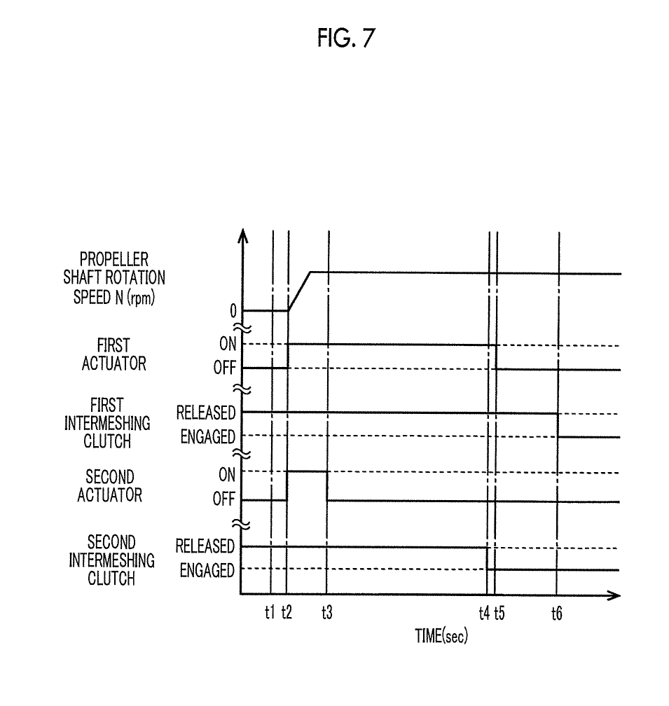

FIG. 6 is a flowchart that illustrates an example of control operations of engagement control for engaging the first intermeshing clutch 24 and the second intermeshing clutch 32 in the electronic control unit 80 when cancellation of disconnection for cancelling the disconnection state. The disconnection state is a state where the first intermeshing clutch 24 and the second intermeshing clutch 32 are released and the propeller shaft 28 is interrupted from transmission of power from the engine 12 and the rear wheels 16R, 16L. The flowchart shown in FIG. 6 is a flowchart that shows the flow after the traveling mode change determination unit 158 shown in FIG. 5 determines that the condition for changing the traveling mode from the two-wheel drive traveling mode to the four-wheel drive traveling mode is satisfied. FIG. 7 is a timing chart in the case where the control operations shown in the flowchart of FIG. 6 are executed. Time t1 in FIG. 7 is time at which the traveling mode change determination unit 158 shown in FIG. 5 determines to change the traveling mode from the two-wheel drive traveling mode to the four-wheel drive traveling mode.

Initially, in step (hereinafter, step is omitted) S1 corresponding to the functions of the first intermeshing clutch control unit 160 and second intermeshing clutch control unit 162, the first electromagnetic coil current I₁ is supplied to the first electromagnetic coil 62, and the first actuator 54 is set to an on state (time t2 in FIG. 7). The second electromagnetic coil current I₂ is supplied to the second electromagnetic coil 126, and the second actuator 118 is set to an on state (time t2 in FIG. 7).

Subsequently, in S2 corresponding to the function of the synchronization determination unit 160a, it is determined whether the rotation speed of the first ring gear 38 has been synchronized with the rotation speed of the input shaft 34 (N≧N₀) in the first intermeshing clutch 24. When negative determination is made in S2, S3 corresponding to the functions of the first intermeshing clutch control unit 160 and second intermeshing clutch control unit 162 is executed. On the other hand, when affirmative determination is made in S2 (time t3 in FIG. 7), S4 corresponding to the function of the second intermeshing clutch control unit 162 is executed. In S3, the first electromagnetic coil current I₁ is continuously supplied to the first electromagnetic coil 62, and the on state of the first actuator 54 is continued. In addition, the second electromagnetic coil current I₂ is continuously supplied to the second electromagnetic coil 126, and the on state of the second actuator 118 is continued. In S4, supply of the second electromagnetic coil current I₂ to the second electromagnetic coil 126 is stopped, and the second actuator 118 is set to an off state (t3 in FIG. 7).

Subsequently, in S5 corresponding to the function of the second engagement determination unit 162a, it is determined whether the second intermeshing clutch 32 is engaged. When negative determination is made in S5, S5 is executed again. That is, this is in a standby state where the process is on standby until the second intermeshing clutch 32 is engaged. When affirmative determination is made in S5 (time t4 in FIG. 7), S6 corresponding to the function of the first intermeshing clutch control unit 160 is executed. In S6, supply of the first electromagnetic coil current I₁ to the first electromagnetic coil 62 is stopped, and the first actuator 54 is set to an off state (t5 in FIG. 7).

Subsequently, in S7 corresponding to the function of the first engagement determination unit 160b, it is determined whether the first intermeshing clutch 24 is engaged. When negative determination is made in S7, S7 is executed again. That is, this is in a standby state where the process is on standby until the first intermeshing clutch 24 is engaged. When affirmative determination is made in S7 (time t6 in FIG. 7), it is determined that the disconnection state is cancelled, after which control ends.

As shown in the flowchart of FIG. 6, the electronic control unit 80 according to the present embodiment, when cancelling the disconnection state, activates the synchromesh mechanism 84 to synchronize the rotation speed of the input shaft 34 with the rotation speed of the first ring gear 38 and then engages the second intermeshing clutch 32. For this reason, as a result of synchronization of the rotation speed of the input shaft 34 with the rotation speed of the first ring gear 38, the rotation speed of the second ring gear 98 is raised to the rotation speed of the differential case 104 via the first intermeshing clutch 24 and the propeller shaft 28. Therefore, the rotation speed of the second ring gear 98 is smoothly synchronized with the rotation speed of the differential case 104 at the time when the second intermeshing clutch 32 is engaged. Since the first intermeshing clutch 24 is engaged after it is determined that the second intermeshing clutch 32 is engaged, the power of the rear wheels 16R, 16L is transmitted to the first ring gear 38 via the second intermeshing clutch 32 and the propeller shaft 28, so a decrease in the rotation speed of the first ring gear 38 is suppressed. This suppresses out of synchronization between the rotation speed of the first ring gear 38 and the rotation speed of the input shaft 34 at the time when the first intermeshing clutch 24 is engaged.

As described above, with the electronic control unit 80 of the four-wheel drive vehicle 10 according to the present embodiment, the synchromesh mechanism 84 is activated when cancelling the disconnection state where the propeller shaft 28 is interrupted from transmission of power from the engine 12 and the rear wheels 16R, 16L. When the electronic control unit 80 determines that the rotation speed of the input shaft 34 has been synchronized with the rotation speed of the first ring gear 38, the electronic control unit 80 engages the second intermeshing clutch 32, and then engages the first intermeshing clutch 24. For this reason, the synchromesh mechanism 84 is activated, and the rotation speed of the second ring gear 98 of the second intermeshing clutch 32 is raised via the first intermeshing clutch 24. Therefore, the rotation speed of the second ring gear 98 is smoothly synchronized with the rotation speed of the differential case 104 at the time when the second intermeshing clutch 32 is engaged. In the first intermeshing clutch 24, a decrease in the rotation speed of the first ring gear 38 is suppressed by engagement of the second intermeshing clutch 32. For this reason, out of synchronization between the rotation speed of the first ring gear 38 and the rotation speed of the input shaft 34 at the time when the first intermeshing clutch 24 is engaged is suppressed.

With the electronic control unit 80 of the four-wheel drive vehicle 10 according to the present embodiment, the synchromesh mechanism 84 synchronizes the rotation speed of the input shaft 34 with the rotation speed of the first ring gear 38 by moving the first movable sleeve 48 in the non-meshing direction F2 in which the first movable sleeve 48 does not mesh with the first ring gear 38. This suitably suppresses out of synchronization between the rotation speed of the first ring gear 38 and the rotation speed of the input shaft 34 at the time when the first movable sleeve 48 is moved in the meshing direction F1 in which the first movable sleeve 48 meshes with the first ring gear 38.

With the electronic control unit 80 of the four-wheel drive vehicle 10 according to the present embodiment, the coupling 94 is provided in the power transmission path between the propeller shaft 28 and the second ring gear 98. For this reason, it is possible to provide suitable meshing without providing a synchromesh mechanism in the second intermeshing clutch 32.

With the electronic control unit 80 of the four-wheel drive vehicle 10 according to the present embodiment, the coupling 94 is engaged when cancelling the disconnection state. For this reason, when the synchromesh mechanism 84 is activated, the rotation speed of the second ring gear 98 of the second intermeshing clutch 32 is suitably raised to the rotation speed of the differential case 104.

With the electronic control unit 80 of the four-wheel drive vehicle 10 according to the present embodiment, the first intermeshing clutch 24 includes the first actuating mechanism 50 that moves the first movable sleeve 48 in the direction of the first rotation axis C1 to move the first movable sleeve 48 between the first connection position at which the first intermeshing clutch 24 is engaged and the first disconnection position at which the first intermeshing clutch 24 is released. The first actuating mechanism 50 includes the first ratchet mechanism 58 that includes the first piston 64a, the second piston 70 and the first holder 72. In the first ratchet mechanism 58, the first piston 64a is reciprocated in the direction of the first rotation axis C1, with the result that the first movable sleeve 48 is moved by the second piston 70 to the first disconnection position against the urging force of the first spring 56. In addition, as the first piston 64a is reciprocated in the direction of the first rotation axis C1 again, the second piston 70 is unlatched from the latch teeth 72a of the first holder 72, and the first movable sleeve 48 is moved to the first connection position under the urging force of the first spring 56. For this reason, even in a state where the first electromagnetic coil current I₁ is not supplied to the first electromagnetic coil 62, the first movable sleeve 48 is latched onto the latch teeth 72a of the first holder 72 via the second piston 70 at the first disconnection position. Therefore, electric power consumption in the first intermeshing clutch 24 is suitably reduced.

With the electronic control unit 80 of the four-wheel drive vehicle 10 according to the present embodiment, the second intermeshing clutch 32 includes the second actuating mechanism 112 that moves the second movable sleeve 110 in the direction of the second rotation axis C2 to move the second movable sleeve 110 between the second connection position at which the second intermeshing clutch 32 is engaged and the second disconnection position at which the second intermeshing clutch 32 is released. The second actuating mechanism 112 includes the second ratchet mechanism 122 that includes the third piston 128a, the fourth piston 134 and the second holder 136. In the second ratchet mechanism 122, when the third piston 128a is reciprocated in the direction of the second rotation axis C2, the second movable sleeve 110 is moved by the fourth piston 134 to the second disconnection position against the urging force of the second spring 120. In addition, as the third piston 128a is reciprocated in the direction of the second rotation axis C2 again, the fourth piston 134 is unlatched from the latch teeth 136a of the second holder 136, and the second movable sleeve 110 is moved to the second connection position under the urging force of the second spring 120. For this reason, even in a state where the second electromagnetic coil current I₂ is not supplied to the second electromagnetic coil 126, the second movable sleeve 110 is latched onto the latch teeth 136a of the second holder 136 via the fourth piston 134 at the second disconnection position. Therefore, electric power consumption in the second intermeshing clutch 32 is suitably reduced.

Next, another embodiment will be described. Like reference numerals denote portions common with the above-described first embodiment, and the description thereof is omitted.

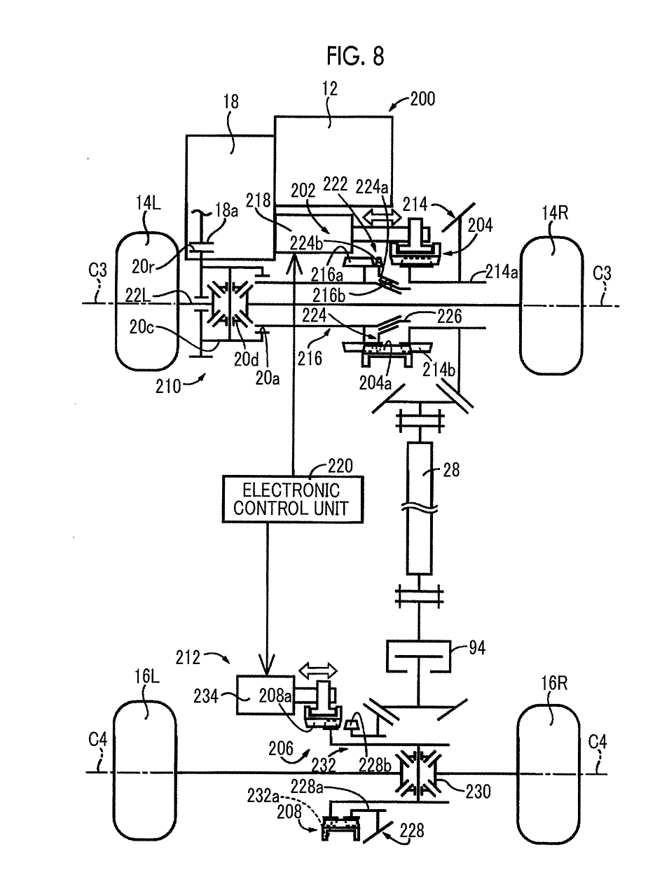

FIG. 8 is a view that illustrates a four-wheel drive vehicle 200 according to another embodiment. The four-wheel drive vehicle 200 according to the present embodiment differs from the four-wheel drive vehicle 10 according to the first embodiment in that a first intermeshing clutch 202 is engaged by moving a first movable sleeve (first sleeve) 204 of a first intermeshing clutch (intermeshing clutch) 202 in one direction. In addition, the four-wheel drive vehicle 200 according to the present embodiment differs from the four-wheel drive vehicle 10 according to the first embodiment in that a second intermeshing clutch 206 is engaged by moving a second movable sleeve (second sleeve) 208 of a second intermeshing clutch (intermeshing clutch) 206 in one direction. The remaining configuration is substantially similar to that of the four-wheel drive vehicle 10 according to the first embodiment.

In the four-wheel drive vehicle 200, in the two-wheel drive mode, driving force transmitted from the engine 12 via the automatic transmission 18 is transmitted to the right and left front wheels 14R, 14L through a front wheel driving force distribution unit 210 and the right and left axles 22R, 22L. In the two-wheel drive mode, at least the first intermeshing clutch 202 is released, and power is not transmitted to the propeller shaft 28, a rear wheel driving force distribution unit 212, or the rear wheels 16. However, in the four-wheel drive mode, in addition to the two-wheel drive mode, both the first intermeshing clutch 202 and the second intermeshing clutch 206 are engaged, so driving force from the engine 12 is transmitted to the propeller shaft 28, the rear wheel driving force distribution unit 212 and the rear wheels 16.

The front wheel driving force distribution unit 210 includes a cylindrical first ring gear (first output rotating member) 214, a cylindrical input shaft (first input rotating member) 216, the first intermeshing clutch 202 including the first movable sleeve 204, and the like. The cylindrical first ring gear 214 is coupled to the propeller shaft 28 such that power is transmittable in order to drive the propeller shaft 28. Part of power that is transmitted from the engine 12 to the front wheels 14R, 14L via the differential case 20c is input to the cylindrical input shaft 216. The first movable sleeve 204 is spline-fitted to the first ring gear 214, and moves in the direction of a third rotation axis (first axis) C3 to selectively mesh with the input shaft 216.

The cylindrical first ring gear 214 is, for example, a bevel gear having helical gear teeth or hypoid gear teeth, and includes a shaft portion 214a that protrudes in substantially a cylindrical shape from the inner peripheral portion of the first ring gear 214 toward the front wheel 14L side. As shown in FIG. 8, the first ring gear 214 is coupled to the rear wheels 16R, 16L via the second intermeshing clutch 206, the propeller shaft 28, and the like, such that power is transmittable. The cylindrical input shaft 216 is supported by a bearing (not shown) such that the input shaft 216 is rotatable around the third rotation axis C3. The bearing (not shown) is provided inside a case that covers the front wheel driving force distribution unit 210. That is, the cylindrical input shaft 216 is supported so as to be rotatable concentrically with the first ring gear 214. The input shaft 216 has outer peripheral spline teeth 216a provided on the outer periphery at the front wheel 14R-side end of the input shaft 216.

The first intermeshing clutch 202 is a separating mechanism (dog clutch) for connecting or interrupting the power transmission path between the engine 12 and the propeller shaft 28. That is, the first intermeshing clutch 202 is a dog clutch for connecting or interrupting the power transmission path between the input shaft 216 and the first ring gear 214. The input shaft 216 is coupled to the engine 12 such that power is transmittable. The first ring gear 214 is coupled to the propeller shaft 28 such that power is transmittable. The first intermeshing clutch 202 includes a third actuator 218. The third actuator 218 moves the first movable sleeve 204 in the direction of the third rotation axis C3 to move the first movable sleeve 204 between a third connection position and a third disconnection position. The third connection position is a position at which the first intermeshing clutch 202 is engaged. The third disconnection position is a position at which the first intermeshing clutch 202 is released. The first movable sleeve 204 has internal teeth 204a provided on the inner periphery of the first movable sleeve 204 such that external teeth 214b are fitted to the internal teeth 204a. The external teeth 214b are provided on the outer periphery at the front wheel 14L side of the shaft portion 214a of the first ring gear 214. When the external teeth 214b of the first ring gear 214 are fitted to the internal teeth 204a of the first movable sleeve 204, the first movable sleeve 204 is supported by the first ring gear 214. That is, when the first movable sleeve 204 is spline-fitted to the first ring gear 214, the first movable sleeve 204 is supported by the first ring gear 214 so as to be relatively non-rotatable with respect to the first ring gear 214 and movable in the direction of the third rotation axis C3. The third connection position is a position at which the internal teeth 204a of the first movable sleeve 204 mesh with the outer peripheral spline teeth 216a of the input shaft 216 as a result of movement of the first movable sleeve 204 in the direction of the third rotation axis C3. At the third connection position, relative rotation between the first ring gear 214 and the input shaft 216 is not allowed. The third disconnection position is a position at which the internal teeth 204a of the first movable sleeve 204 do not mesh with the outer peripheral spline teeth 216a of the input shaft 216 as a result of movement of the first movable sleeve 204 in the direction of the third rotation axis C3. At the third disconnection position, relative rotation between the first ring gear 214 and the input shaft 216 is allowed. The third actuator 218 moves the first movable sleeve 204 in the direction of the third rotation axis C3 in response to a command signal that is output from the electronic control unit 220.

The first intermeshing clutch 202 includes a synchromesh mechanism 222 arranged in series with the first movable sleeve 204 in the direction of the third rotation axis C3. As shown in FIG. 8, the synchromesh mechanism 222 includes a conical outer peripheral friction face 216b, an annular synchronizer ring 224 and an annular friction ring 226. The conical outer peripheral friction face 216b is provided on the outer periphery at the front wheel 14R-side end of the input shaft 216. The synchronizer ring 224 is arranged between the outer peripheral spline teeth 216a of the input shaft 216 and the external teeth 214b of the first ring gear 214. The friction ring 226 is arranged between a conical inner peripheral friction face 224a and the conical outer peripheral friction face 216b of the input shaft 216. The conical inner peripheral friction face 224a is formed on the synchronizer ring 224. Outer peripheral spline teeth 224b are provided on the outer periphery of the synchronizer ring 224. The outer peripheral spline teeth 224b can mesh with the internal teeth 204a of the first movable sleeve 204 so as to be relatively non-rotatable and movable in the direction of the third rotation axis C3.

In the synchromesh mechanism 84, at the time when the first movable sleeve 204 is moved by the third actuator 218 from the third disconnection position to the third connection position, the first movable sleeve 204 contacts the outer peripheral spline teeth 224b of the synchronizer ring 224. For this reason, the conical inner peripheral friction face 224a of the synchronizer ring 224 and the friction ring 226 are in sliding contact with each other, and the friction ring 226 and the conical outer peripheral friction face 216b of the input shaft 216 are in sliding contact with each other, with the result that the rotation speed of the first movable sleeve 204, that is, the rotation speed of the first ring gear 214, is raised toward the rotation speed of the input shaft 216. When the rotation speed of the input shaft 216 and the rotation speed of the first ring gear 214 have been synchronized with each other, the internal teeth 204a of the first movable sleeve 204 move along the outer peripheral spline teeth 224b of the synchronizer ring 224, and the internal teeth 204a of the first movable sleeve 204 mesh with the outer peripheral spline teeth 216a of the input shaft 216.

The rear wheel driving force distribution unit 212 includes a cylindrical second ring gear (second output rotating member) 228, a differential case 232 (second output rotating member) of a differential gear unit 230, and the second intermeshing clutch 206. The cylindrical second ring gear 228 is provided in the power transmission path between the propeller shaft 28 and the rear wheels 16R, 16L, and is coupled to the propeller shaft 28 such that power is transmittable. The differential case 232 is provided in the power transmission path between the propeller shaft 28 and the rear wheels 16R, 16L, and is coupled to the rear wheels 16R, 16L such that power is transmittable. The second intermeshing clutch 206 is an intermeshing dog clutch (separating device) for connecting the propeller shaft 28 to the right and left rear wheels 16R, 16L or disconnecting the propeller shaft 28 from the right and left rear wheels 16R, 16L, that is, for connecting the second ring gear 228 to the differential case 232 or disconnecting the second ring gear 228 from the differential case 232.

The second ring gear 228 is, for example, a bevel gear having hypoid gear teeth, and includes a shaft portion 228a that protrudes in substantially a cylindrical shape from the inner peripheral portion of the second ring gear 228 toward the rear wheel 16L side. The differential case 232 is supported by a bearing (not shown) such that the differential case 232 is rotatable around a fourth rotation axis (second axis) C4. The bearing (not shown) is provided inside a case that covers the rear wheel driving force distribution unit 212. That is, the differential case 232 is supported so as to be rotatable concentrically with the second ring gear 228.

The second intermeshing clutch 206 is a separating mechanism (dog clutch) for connecting or interrupting the power transmission path between the propeller shaft 28 and the right and left rear wheels 16R, 16L. That is, the second intermeshing clutch 206 is a dog clutch for connecting or interrupting the power transmission path between the second ring gear 228 and the differential case 232 of the differential gear unit 230. The second ring gear 228 is coupled to the propeller shaft 28 such that power is transmittable. The differential case 232 is coupled to the rear wheels 16R, 16L such that power is transmittable. The second intermeshing clutch 206 includes a fourth actuator 234. The fourth actuator 234 moves the second movable sleeve 208 in the direction of the fourth rotation axis C4 to move the second movable sleeve 208 between a fourth connection position and a fourth disconnection position. The fourth connection position is a position at which the second intermeshing clutch 206 is engaged. The fourth disconnection position is a position at which the second intermeshing clutch 206 is released. The second movable sleeve 208 has internal teeth 208a. The internal teeth 208a are provided on the inner periphery of the second movable sleeve 208 so as to be fitted to outer peripheral spline teeth 232a. The outer peripheral spline teeth 232a are provided on the outer periphery at the second movable sleeve 208-side end of the differential case 232. When the outer peripheral spline teeth 232a provided on the differential case 232 are fitted to the internal teeth 208a of the second movable sleeve 208, the second movable sleeve 208 is supported by the differential case 232. That is, when the second movable sleeve 208 is spline-fitted to the differential case 232, the second movable sleeve 208 is supported by the differential case 232 so as to be relatively non-rotatable with respect to the differential case 232 and movable in the direction of the fourth rotation axis C4. The second ring gear 228 has external teeth 228b provided on the outer periphery at the rear wheel 16L side of the shaft portion 228a of the second ring gear 228. The fourth connection position is a position at which the internal teeth 208a of the second movable sleeve 208 mesh with the external teeth 228b of the second ring gear 228 as a result of movement of the second movable sleeve 208 in the direction of the fourth rotation axis C4. At the fourth connection position, relative rotation between the second ring gear 228 and the differential case 232 is not allowed. The fourth disconnection position is a position at which the internal teeth 208a of the second movable sleeve 208 do not mesh with the external teeth 228b of the second ring gear 228 as a result of movement of the second movable sleeve 208 in the direction of the fourth rotation axis C4. At the fourth disconnection position, relative rotation between the second ring gear 228 and the differential case 232 is allowed. The fourth actuator 234 moves the second movable sleeve 208 in the direction of the fourth rotation axis C4 in response to a command signal that is output from the electronic control unit 220.

With the thus configured four-wheel drive vehicle 200, for example, when the two-wheel drive traveling mode is selected by the electronic control unit 220 in the four-wheel drive mode in which both the first intermeshing clutch 202 and the second intermeshing clutch 206 are engaged, the first movable sleeve 204 is moved by the third actuator 218 from the third connection position to the third disconnection position, and the first intermeshing clutch 202 is released. In addition, the second movable sleeve 208 is moved by the fourth actuator 234 from the fourth connection position to the fourth disconnection position, and the second intermeshing clutch 206 is released. Therefore, a disconnection state is established. In the disconnection state, the propeller shaft 28 is interrupted from transmission of power from the engine 12 that is a driving source and the rear wheels 16 that are the auxiliary drive wheels. When the four-wheel drive traveling mode is selected by the electronic control unit 220 in the disconnection state, the first movable sleeve 204 is moved to the third connection position in response to a command signal that is output from the electronic control unit 220 to the third actuator 218. Thus, the synchromesh mechanism 222 is activated, and the rotation speed of the input shaft 216 is synchronized with the rotation speed of the first ring gear 214. In the electronic control unit 220, when it is determined that the rotation speed of the input shaft 216 has been synchronized with the rotation speed of the first ring gear 214 on the basis of input signals that are detected by the sensors provided in the four-wheel drive vehicle 200, the second movable sleeve 208 is moved from the fourth disconnection position to the fourth connection position in response to a command signal that is output from the electronic control unit 220 to the fourth actuator 234, and the second intermeshing clutch 206 is engaged. In the electronic control unit 220, when it is determined that the second intermeshing clutch 206 is engaged on the basis of input signals that are detected by the sensors provided in the four-wheel drive vehicle 200, the first movable sleeve 204 is also moved toward the fourth connection position in response to a command signal that is output from the electronic control unit 220 to the third actuator 218, and the first intermeshing clutch 202 is engaged. Thus, the first intermeshing clutch 202 and the second intermeshing clutch 206 are engaged, and the disconnection state is cancelled. The electronic control unit 220, as well as the electronic control unit 80, includes the traveling mode change determination unit 158, the first intermeshing clutch control unit 160, the synchronization determination unit 160a, the first engagement determination unit 160b, the second intermeshing clutch control unit 162 and the second engagement determination unit 162a.

The embodiments are described in detail with reference to the accompanying drawings; however, the disclosure is also applied to another mode.

For example, each of the four-wheel drive vehicles 10, 200 according to the above-described embodiments is a front-engine front-drive (FF)-based vehicle. Instead, the disclosure may be implemented in any combination as needed, such as a front-engine rear-drive (FR)-based vehicle and a rear-engine rear-drive (RR)-based vehicle.

In the four-wheel drive vehicle 10 according to the above-described embodiment, the first intermeshing clutch 24 includes the synchromesh mechanism 84, and the second intermeshing clutch 32 does not include a synchromesh mechanism. However, for example, the four-wheel drive vehicle 10 may be configured such that the second intermeshing clutch 32 includes a synchromesh mechanism and the first intermeshing clutch 24 does not include a synchromesh mechanism. In the case of such a configuration, when the synchromesh mechanism is activated and it is determined that the rotation speed of the differential case 104 has been synchronized with the rotation speed of the second ring gear 98, the electronic control unit 80 is controlled so as to engage the first intermeshing clutch 24 and then engage the second intermeshing clutch 32.

In the four-wheel drive vehicle 200 according to the above-described embodiment, the first intermeshing clutch 202 includes the synchromesh mechanism 222, and the second intermeshing clutch 206 does not include a synchromesh mechanism. However, for example, the four-wheel drive vehicle 200 may be configured such that the second intermeshing clutch 206 includes a synchromesh mechanism and the first intermeshing clutch 202 does not include a synchromesh mechanism. In the case of such a configuration, when the synchromesh mechanism is activated and it is determined that the rotation speed of the differential case 232 has been synchronized with the rotation speed of the second ring gear 228, the electronic control unit 220 is controlled so as to engage the first intermeshing clutch 202 and then engage the second intermeshing clutch 206.

In the second intermeshing clutch 32 according to the above-described embodiment, the second movable sleeve 110 is spline-fitted to the differential case 104, and moves in the direction of the second rotation axis C2 to selectively mesh with the second ring gear 98. However, for example, the configuration of the second intermeshing clutch 32 may be changed such that the second intermeshing clutch 32 is spline-fitted to the second ring gear 98 and moves in the direction of the second rotation axis C2 to selectively mesh with the differential case 104. In the second intermeshing clutch 206 according to the above-described embodiment, the second movable sleeve 208 is spline-fitted to the differential case 232 and moves in the direction of the fourth rotation axis C4 to selectively mesh with the second ring gear 228. However, for example, the configuration of the second intermeshing clutch 206 may be changed such that the second intermeshing clutch 206 is spline-fitted to the second ring gear 228 and moves in the direction of the fourth rotation axis C4 to selectively mesh with the differential case 232.

In the electronic control unit 80 according to the above-described embodiment, the first intermeshing clutch control unit 160 supplies the first electromagnetic coil current I₁ to the first electromagnetic coil 62, and the second intermeshing clutch control unit 162 supplies the second electromagnetic coil current I₂ to the second electromagnetic coil 126. When the synchronization determination unit 160a determines that the rotation speed of the input shaft 34 has been synchronized with the rotation speed of the first ring gear 38, the electronic control unit 80 causes the second intermeshing clutch control unit 162 to engage the second intermeshing clutch 32 by stopping supply of the second electromagnetic coil current I₂ to the second electromagnetic coil 126. However, for example, after a predetermined time set in advance has elapsed, the second intermeshing clutch control unit 162 may engage the second intermeshing clutch 32 by stopping supply of the second electromagnetic coil current I₂ to the second electromagnetic coil 126.

In the electronic control unit 80 according to the above-described embodiment, when the traveling mode change determination unit 158 determines to change the traveling mode from the two-wheel drive traveling mode to the four-wheel drive traveling mode, the first intermeshing clutch control unit 160 engages the coupling 94. However, it is not always required to engage the coupling 94. In the disconnection state, as the synchromesh mechanism 84 is activated and the propeller shaft 28 rotates, the second ring gear 98 rotates due to a drag of the coupling 94 even when the coupling 94 is released. Each of the four-wheel drive vehicles 10, 200 according to the above-described embodiments includes the coupling 94; however, the coupling 94 does not always need to be provided.

In the four-wheel drive vehicle 10 according to the above-described embodiment, the first actuating mechanism 50 reciprocates the first movable sleeve 48 in the direction of the first rotation axis C1 with the use of the first ball cam 52, the first actuator 54, the first spring 56 and the first ratchet mechanism 58. However, the first actuating mechanism 50 may have any configuration as long as the first actuating mechanism 50 reciprocates the first movable sleeve 48 in the direction of the first rotation axis C1. In the four-wheel drive vehicle 10 according to the above-described embodiment, the second actuating mechanism 112 reciprocates the second movable sleeve 110 in the direction of the second rotation axis C2 with the use of the second ball cam 116, the second actuator 118, the second spring 120 and the second ratchet mechanism 122. However, the second actuating mechanism 112 may have any configuration as long as the second actuating mechanism 112 reciprocates the second movable sleeve 110 in the direction of the second rotation axis C2.

In the first ratchet mechanism 58 according to the above-described embodiment, the number of steps of the receiving teeth 64d, 64e of the first piston 64a and the number of steps of the latch teeth 72a, 72b of the first holder 72 are two. Instead, for example, the number of steps may be three or more. In the second ratchet mechanism 122 according to the above-described embodiment, the number of steps of the receiving teeth 128d, 128e of the third piston 128a and the number of steps of the latch teeth 136a, 136b of the second holder 136 are two. Instead, for example, the number of steps may be three or more.

The above-described embodiments are only illustrative. The disclosure may be implemented in a mode including various modifications or improvements on the basis of the knowledge of persons skilled in the art.

What is claimed is:

1. A control system for a vehicle, the control system comprising:
main drive wheels;
auxiliary drive wheels;
a first input rotating member configured to be input part of power that is transmitted from a driving source to the main drive wheels;
a first output rotating member coupled to the auxiliary drive wheels via a power transmission member, the first output rotating member being configured to rotate around a first axis around which the first input rotating member rotates;
a first intermeshing clutch including a first sleeve, the first sleeve being spline-fitted to one of the first input rotating member and the first output rotating member, the first sleeve being configured to move in a direction of the first axis to selectively mesh with the other one of the first input rotating member and the first output rotating member;
a second input rotating member provided in a power transmission path between the power transmission member and the auxiliary drive wheels, the second input rotating member being configured to be coupled to the auxiliary drive wheels;
a second output rotating member provided in the power transmission path between the power transmission member and the auxiliary drive wheels, the second output rotating member being configured to rotate around a second axis around which the second input rotating member rotates;
a second intermeshing clutch including a second sleeve, the second sleeve being spline-fitted to one of the second input rotating member and the second output rotating member, the second sleeve being configured to move in a direction of the second axis to selectively mesh with the other one of the second input rotating member and the second output rotating member;
a synchromesh mechanism provided in the first intermeshing clutch, the synchromesh mechanism being arranged in series with the first sleeve in the direction of the first axis, the synchromesh mechanism being configured to synchronize a rotation speed of the first input rotating member with a rotation speed of the first output rotating member by moving the first sleeve in the direction of the first axis; and
an electronic control unit configured to
activate the synchromesh mechanism when cancelling a disconnection state where the power transmission member is disconnected from transmission of power from the driving source and the auxiliary drive wheels, and
the electronic control unit being configured to engage the second intermeshing clutch and then engage the first intermeshing clutch when the electronic control unit determines that the rotation speed of the first input rotating member has been synchronized with the rotation speed of the first output rotating member.

2. The control system according to claim 1, wherein
the main drive wheels are front wheels, and the auxiliary drive wheels are rear wheels,
the first sleeve is spline-fitted to the first input rotating member, and the first sleeve is configured to move in the direction of the first axis to selectively mesh with the first output rotating member,
the second sleeve is spline-fitted to the second input rotating member, and the second sleeve is configured to move in the direction of the second axis to selectively mesh with the second output rotating member, and
the electronic control unit is configured to activate the synchromesh mechanism when cancelling the disconnection state, the electronic control unit is configured to synchronize the rotation speed of the first input rotating member with the rotation speed of the first output rotating member and then engage the second intermeshing clutch, and the electronic control unit is configured to engage the second intermeshing clutch and then engage the first intermeshing clutch.

3. The control system according to claim 2, wherein
the synchromesh mechanism is configured to synchronize the rotation speed of the first input rotating member with the rotation speed of the first output rotating member by moving the first sleeve in the direction of the first axis and in a non-meshing direction in which the first sleeve does not mesh with the first output rotating member.

4. The control system according to claim 1, further comprising
a coupling provided in a power transmission path between the power transmission member and the second output rotating member.

5. The control system according to claim 4, wherein
the electronic control unit is configured to engage the coupling when cancelling the disconnection state.

6. The control system according to claim 1, further comprising
a first actuating mechanism provided in the first intermeshing clutch, the first actuating mechanism being configured to move the first sleeve in the direction of the first axis to move the first sleeve between a first connection position and a first disconnection position, the first connection position being a position at which the first intermeshing clutch is engaged, the first disconnection position being a position at which the first intermeshing clutch is released, the first actuating mechanism including a first latch mechanism,
the first latch mechanism including
a first piston configured to reciprocate in the direction of the first axis by a predetermined stroke as a first electromagnetic coil attracts a movable piece as a result of supplying a first electromagnetic coil current from the electronic control unit to the first electromagnetic coil,
a second piston configured to be moved by the first piston in the direction of the first axis against an urging force of a first spring, and
a first holder having latch teeth, the first holder being configured to latch the second piston, moved by the first piston, with the latch teeth,
the first latch mechanism being configured such that the first sleeve is moved to the first disconnection position by the second piston as a result of reciprocating the first piston in the direction of the first axis, and the first latch mechanism being configured such that the second piston is unlatched from the latch teeth of the first holder and the first sleeve is moved to the first connection position when the first piston is reciprocated in the direction of the first axis again.

7. The control system according to claim 1, further comprising
a second actuating mechanism provided in the second intermeshing clutch, the second actuating mechanism being configured to move the second sleeve in the direction of the second axis to move the second sleeve between a second connection position and a second disconnection position, the second connection position being a position at which the second intermeshing clutch is engaged, the second disconnection position being a position at which the second intermeshing clutch is released, the second actuating mechanism including a second latch mechanism,
the second latch mechanism including
a third piston configured to reciprocate in the direction of the second axis by a predetermined stroke as a second electromagnetic coil attracts a movable piece as a result of supplying a second electromagnetic coil current from the electronic control unit to the second electromagnetic coil,
a fourth piston configured to be moved by the third piston in the direction of the second axis against an urging force of a second spring, and
a second holder having latch teeth, the second holder being configured to latch the fourth piston, moved by the third piston, with the latch teeth,
the second latch mechanism being configured such that the second sleeve is moved to the second disconnection position by the fourth piston as a result of reciprocating the third piston in the direction of the second axis, and the second latch mechanism being configured such that the fourth piston is unlatched from the latch teeth of the second holder and the second sleeve is moved to the second connection position when the third piston is reciprocated in the direction of the second axis again.

8. A control system for a vehicle, the control system comprising:
main drive wheels;
auxiliary drive wheels;
a first input rotating member configured to be input part of power that is transmitted from a driving source to the main drive wheels;
a first output rotating member coupled to the auxiliary drive wheels via a power transmission member, the first output rotating member being configured to rotate around a first axis around which the first input rotating member rotates;
a first intermeshing clutch including a first sleeve, the first sleeve being spline-fitted to one of the first input rotating member and the first output rotating member, the first sleeve being configured to move in a direction of the first axis to selectively mesh with the other one of the first input rotating member and the first output rotating member;
a second input rotating member provided in a power transmission path between the power transmission member and the auxiliary drive wheels, the second input rotating member being configured to be coupled to the auxiliary drive wheels;
a second output rotating member provided in the power transmission path between the power transmission member and the auxiliary drive wheels, the second output rotating member being configured to rotate around a second axis around which the second input rotating member rotates;
a second intermeshing clutch including a second sleeve, the second sleeve being spline-fitted to one of the second input rotating member and the second output rotating member, the second sleeve being configured to move in a direction of the second axis to selectively mesh with the other one of the second input rotating member and the second output rotating member;
a synchromesh mechanism provided in the second intermeshing clutch, the synchromesh mechanism being arranged in series with the second sleeve in the direction of the second axis, the synchromesh mechanism being configured to synchronize a rotation speed of the second input rotating member with a rotation speed of the second output rotating member by moving the second sleeve in the direction of the second axis; and
an electronic control unit configured to activate the synchromesh mechanism when cancelling a disconnection state where the power transmission member is disconnected from transmission of power from the driving source and the auxiliary drive wheels, and
the electronic control unit being configured to engage the first intermeshing clutch and then engage the second intermeshing clutch when the electronic control unit determines that the rotation speed of the second input rotating member has been synchronized with the rotation speed of the second output rotating member.

9. The control system according to claim 8, further comprising:
a coupling provided in a power transmission path between the power transmission member and the second output rotating member.

10. The control system according to claim 9, wherein
the electronic control unit is configured to engage the coupling when cancelling the disconnection state.

11. The control system according to claim 8, further comprising
a first actuating mechanism provided in the first intermeshing clutch, the first actuating mechanism being configured to move the first sleeve in the direction of the first axis to move the first sleeve between a first connection position and a first disconnection position, the first connection position being a position at which the first intermeshing clutch is engaged, the first disconnection position being a position at which the first intermeshing clutch is released, the first actuating mechanism including a first latch mechanism,
the first latch mechanism including
a first piston configured to reciprocate in the direction of the first axis by a predetermined stroke as a first electromagnetic coil attracts a movable piece as a result of supplying a first electromagnetic coil current from the electronic control unit to the first electromagnetic coil,
a second piston configured to be moved by the first piston in the direction of the first axis against an urging force of a first spring, and
a first holder having latch teeth, the first holder being configured to latch the second piston, moved by the first piston, with the latch teeth,
the first latch mechanism being configured such that the first sleeve is moved to the first disconnection position by the second piston as a result of reciprocating the first piston in the direction of the first axis, and the first latch mechanism being configured such that the second piston is unlatched from the latch teeth of the first holder and the first sleeve is moved to the first connection position when the first piston is reciprocated in the direction of the first axis again.

12. The control system according to claim 8, further comprising
a second actuating mechanism provided in the second intermeshing clutch, the second actuating mechanism being configured to move the second sleeve in the direction of the second axis to move the second sleeve between a second connection position and a second disconnection position, the second connection position being a position at which the second intermeshing clutch is engaged, the second disconnection position being a position at which the second intermeshing clutch is released, the second actuating mechanism including a second latch mechanism,
the second latch mechanism including
a third piston configured to reciprocate in the direction of the second axis by a predetermined stroke as a second electromagnetic coil attracts a movable piece as a result of supplying a second electromagnetic coil current from the electronic control unit to the second electromagnetic coil,
a fourth piston configured to be moved by the third piston in the direction of the second axis against an urging force of a second spring, and
a second holder having latch teeth, the second holder being configured to latch the fourth piston, moved by the third piston, with the latch teeth,
the second latch mechanism being configured such that the second sleeve is moved to the second disconnection position by the fourth piston as a result of reciprocating the third piston in the direction of the second axis, and the second latch mechanism being configured such that the fourth piston is unlatched from the latch teeth of the second holder and the second sleeve is moved to the second connection position when the third piston is reciprocated in the direction of the second axis again.

13. A control method for a vehicle, the vehicle including
main drive wheels,
auxiliary drive wheels,
a first input rotating member configured to be input part of power that is transmitted from a driving source to the main drive wheels,
a first output rotating member coupled to the auxiliary drive wheels via a power transmission member, the first output rotating member being configured to rotate around a first axis around which the first input rotating member rotates,
a first intermeshing clutch including a first sleeve, the first sleeve being spline-fitted to one of the first input rotating member and the first output rotating member, the first sleeve being configured to move in a direction of the first axis to selectively mesh with the other one of the first input rotating member and the first output rotating member,
a second input rotating member provided in a power transmission path between the power transmission member and the auxiliary drive wheels, the second input rotating member being configured to be coupled to the auxiliary drive wheels,
a second output rotating member provided in the power transmission path between the power transmission member and the auxiliary drive wheels, the second output rotating member being configured to rotate around a second axis around which the second input rotating member rotates,
a second intermeshing clutch including a second sleeve, the second sleeve being spline-fitted to one of the second input rotating member and the second output rotating member, the second sleeve being configured to move in a direction of the second axis to selectively mesh with the other one of the second input rotating member and the second output rotating member,
a synchromesh mechanism provided in the first intermeshing clutch, the synchromesh mechanism being arranged in series with the first sleeve in the direction of the first axis, the synchromesh mechanism being configured to synchronize a rotation speed of the first input rotating member with a rotation speed of the first output rotating member by moving the first sleeve in the direction of the first axis, and
an electronic control unit,
the control method comprising:
activating, by the electronic control unit, the synchromesh mechanism when cancelling a disconnection state where the power transmission member is disconnected from transmission of power from the driving source and the auxiliary drive wheels; and
engaging, by the electronic control unit, the second intermeshing clutch and then engaging the first intermeshing clutch when the electronic control unit determines that the rotation speed of the first input rotating member has been synchronized with the rotation speed of the first output rotating member.

14. The control method according to claim 13, further comprising:
engaging a coupling when cancelling the disconnection state, the coupling being provided in a power transmission path between the power transmission member and the second output rotating member.

15. A control method for a vehicle, the vehicle including
main drive wheels,
auxiliary drive wheels,
a first input rotating member configured to be input part of power that is transmitted from a driving source to the main drive wheels,
a first output rotating member coupled to the auxiliary drive wheels via a power transmission member, the first output rotating member being configured to rotate around a first axis around which the first input rotating member rotates,
a first intermeshing clutch including a first sleeve, the first sleeve being spline-fitted to one of the first input rotating member and the first output rotating member, the first sleeve being configured to move in a direction of the first axis to selectively mesh with the other one of the first input rotating member and the first output rotating member,
a second input rotating member provided in a power transmission path between the power transmission member and the auxiliary drive wheels, the second input rotating member being configured to be coupled to the auxiliary drive wheels,
a second output rotating member provided in the power transmission path between the power transmission member and the auxiliary drive wheels, the second output rotating member being configured to rotate around a second axis around which the second input rotating member rotates,
a second intermeshing clutch including a second sleeve, the second sleeve being spline-fitted to one of the second input rotating member and the second output rotating member, the second sleeve being configured to move in a direction of the second axis to selectively mesh with the other one of the second input rotating member and the second output rotating member,
a synchromesh mechanism provided in the second intermeshing clutch, the synchromesh mechanism being arranged in series with the second sleeve in the direction of the second axis, the synchromesh mechanism being configured to synchronize a rotation speed of the second input rotating member with a rotation speed of the second output rotating member by moving the second sleeve in the direction of the second axis, and
an electronic control unit,
the control method comprising:
activating, by the electronic control unit, the synchromesh mechanism when cancelling a disconnection state where the power transmission member is disconnected from transmission of power from the driving source and the auxiliary drive wheels; and
engaging, by the electronic control unit, the first intermeshing clutch and then engaging the second intermeshing clutch when the electronic control unit determines that the rotation speed of the second input rotating member has been synchronized with the rotation speed of the second output rotating member.

16. The control method according to claim 15, further comprising
engaging a coupling when cancelling the disconnection state, the coupling being provided in a power transmission path between the power transmission member and the second output rotating member.
